(19) United States
(12) Patent Application Publication
(10) Pub. No.: US 2026/0288467 A1
(43) Pub. Date: Sep. 24, 2026

(54) MAINTAINING STATE INFORMATION

(71) Applicant: Arm Limited, Cambridge (GB)

(72) Inventors: Mbou Eyole, Cambridge (GB); Richard Roy Grisenthwaite, Cambridge (GB); Robert Gwilym Dimond, Cambridge (GB)

(73) Assignee: Arm Limited, Cambridge (GB)

(21) Appl. No.: 19/490,138

(22) PCT Filed: Feb. 7, 2024
(86) PCT No.: PCT/GB2024/050341

§ 371 Date: Dec. 4, 2025

(30) Foreign Application Priority Data
Jun. 5, 2023 (GB) 2308383.5

(51) Int. Cl. G06F 9/38; G06F 9/30; G06F 9/46; G06F 21/78

(52) U.S. Cl. CPC G06F 9/3871; G06F 9/30079; G06F 9/461; G06F 21/78

(57) ABSTRACT

There is provided an apparatus, a method of operating an apparatus, a computer program, and a computer-readable medium. The apparatus comprises a pipeline for processing instructions. The pipeline comprises decoder circuitry responsive to receipt of the instructions to control the pipeline to perform processing operations. The apparatus further comprises extension processing circuitry responsive to identification, by the pipeline, of a delegated task to perform the delegated task asynchronously to the pipeline and configured to maintain extension state information indicative of an execution context of the extension processing circuitry independent of processing state information associated with the pipeline. The decoder circuitry is responsive an extension context save instruction comprising a storage location identifier, at a point of storing the extension state information, to store the extension state information to a location identified by the storage location identifier.

This invention relates to an apparatus, a method of operating an apparatus, a computer program, and a computer-readable medium.

Some apparatuses comprise data processing pipelines that are arranged to process sequences of instructions. Such apparatuses may also generate and maintain state information that is associated with the data processing pipeline.

According to a first aspect of the invention there is provided an apparatus comprising:
a data processing pipeline for processing a sequence of instructions, wherein the data processing pipeline comprises decoder circuitry responsive to receipt of instructions of the sequence of instructions to generate control signals to control the data processing pipeline to perform processing operations; and
extension processing circuitry responsive to identification, by the data processing pipeline, of a delegated task to perform the delegated task asynchronously to the data processing pipeline,
wherein:
the extension processing circuitry is configured to maintain extension state information indicative of an execution context of the extension processing circuitry independent of processing state information associated with the data processing pipeline; and
the decoder circuitry is responsive to an extension context save instruction comprising a storage location identifier, at a point of storing the extension state information, to store the extension state information to a location identified by the storage location identifier.

According to a second aspect of the invention there is provided a method of operating an apparatus comprising a data processing pipeline for processing a sequence of instructions, wherein the data processing pipeline comprises decoder circuitry responsive to receipt of instructions of the sequence of instructions, to generate control signals to control the data processing pipeline to perform processing operations, the method comprising:
with extension processing circuitry and in response to identification, by the data processing pipeline, of a delegated task, performing the delegated task asynchronously to the data processing pipeline;
maintaining, using the extension processing circuitry, extension state information indicative of an execution context of the extension processing circuitry independent of processing state information associated with the data processing pipeline; and
with the decoder circuitry, in response to an extension context save instruction comprising a storage location identifier, at a point of storing the extension state information, storing the extension state information to a location identified by the storage location identifier.

According to a third aspect of the invention there is provided a computer program for controlling a host data processing apparatus to provide an instruction execution environment, the computer program comprising:
data processing pipeline logic for processing a sequence of instructions, wherein the data processing pipeline logic comprises decoder logic responsive to receipt of instructions of the sequence of instructions, to generate control signals to control the data processing pipeline logic to perform processing operations; and
extension processing logic responsive to identification, by the data processing pipeline logic, of a delegated task, to perform the delegated task asynchronously to the data processing pipeline logic,
wherein:
the extension processing logic configured to maintain extension state information indicative of an execution context of the extension processing logic independent of processing state information associated with the data processing pipeline logic; and
the decoder logic is responsive to an extension context save instruction comprising a storage location identifier, at a point of storing the extension state information, to store the extension state information to a location identified by the storage location identifier.

According to a fourth aspect of the invention there is provided an apparatus comprising:
a data processing pipeline for processing a sequence of instructions, wherein the data processing pipeline comprises decoder circuitry responsive to receipt of instructions of the sequence of instructions to generate control signals to control the data processing pipeline to perform processing operations; and
extension processing circuitry responsive to identification, by the data processing pipeline, of a delegated task to perform the delegated task asynchronously to the data processing pipeline,
wherein:
the extension processing circuitry is configured to maintain extension state information indicative of an execution context of the extension processing circuitry independent of processing state information associated with the data processing pipeline; and
the decoder circuitry is responsive to an extension context restore instruction comprising a storage location identifier, to trigger the extension processing circuitry, in response to an indication that restoration of previous extension state information associated with the previous execution context is required, to load the previous extension state information from a location identified by the storage location identifier.

According to a fifth aspect of the invention there is provided a method of operating an apparatus comprising a data processing pipeline for processing a sequence of instructions, wherein the data processing pipeline comprises decoder circuitry responsive to receipt of instructions of the sequence of instructions, to generate control signals to control the data processing pipeline to perform processing operations, the method comprising:
with extension processing circuitry and in response to identification, by the data processing pipeline, of a delegated task, performing the delegated task asynchronously to the data processing pipeline;
maintaining, using the extension processing circuitry, extension state information indicative of an execution context of the extension processing circuitry independent of processing state information associated with the data processing pipeline; and
with the decoder circuitry, in response to an extension context restore instruction comprising a storage location identifier, triggering the extension processing circuitry to, load the previous extension state information from a location identified by the storage location identifier in response to an indication that restoration of previous extension state information associated with the previous execution context is required.

According to a sixth aspect of the invention there is provided a computer program for controlling a host data processing apparatus to provide an instruction execution environment, the computer program comprising:
data processing pipeline logic for processing a sequence of instructions, wherein the data processing pipeline logic comprises decoder logic responsive to receipt of instructions of the sequence of instructions, to generate control signals to control the data processing pipeline logic to perform processing operations; and
extension processing logic responsive to identification, by the data processing pipeline logic, of a delegated task, to perform the delegated task asynchronously to the data processing pipeline logic,
wherein:
the extension processing logic configured to maintain extension state information indicative of an execution context of the extension processing logic independent of processing state information associated with the data processing pipeline logic; and
the decoder logic is responsive to an extension context restore instruction comprising a storage location identifier, to trigger the extension processing logic to, in response to an indication that restoration of previous extension state information associated with the previous execution context is required, to load the previous extension state information from a location identified by the storage location identifier.

In some configurations the computer program according to the third and sixth aspect of the invention is stored on a computer-readable medium. In some configurations, the computer-readable medium is a non-transitory computer-readable medium.

In some configurations there is provided a computer-readable medium to store computer-readable code for fabrication of the apparatus according to the above aspects. In some configurations the computer-readable medium is a non-transitory computer-readable medium.

The present techniques will be described further, by way of example only, with reference to configurations thereof as illustrated in the accompanying drawings, in which:

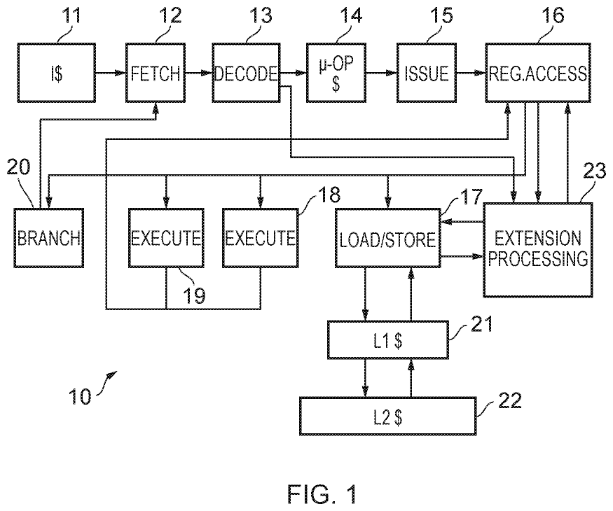

FIG. 1 schematically illustrates a data processing apparatus which May embody various examples of the present techniques;

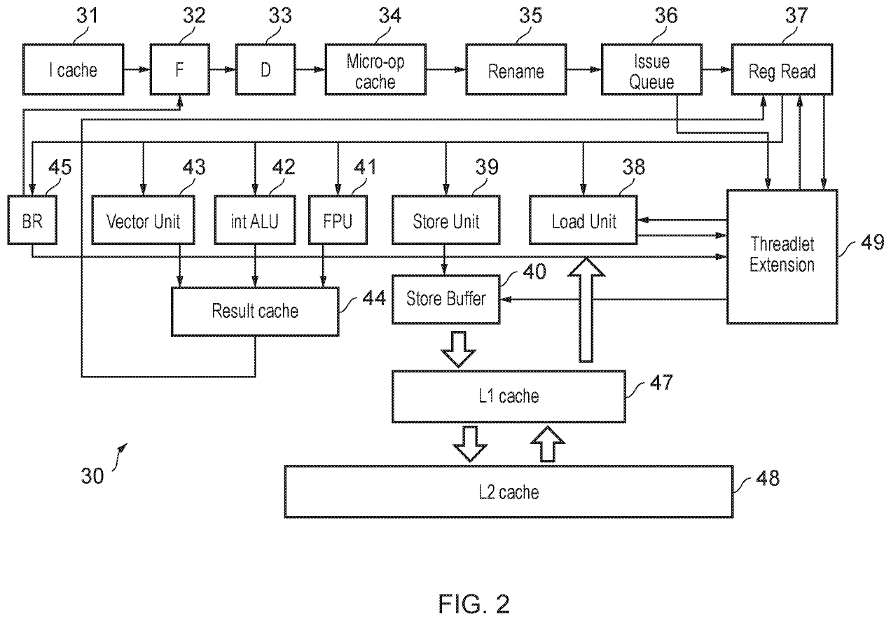

FIG. 2 schematically illustrates a data processing apparatus which may embody various examples of the present techniques;

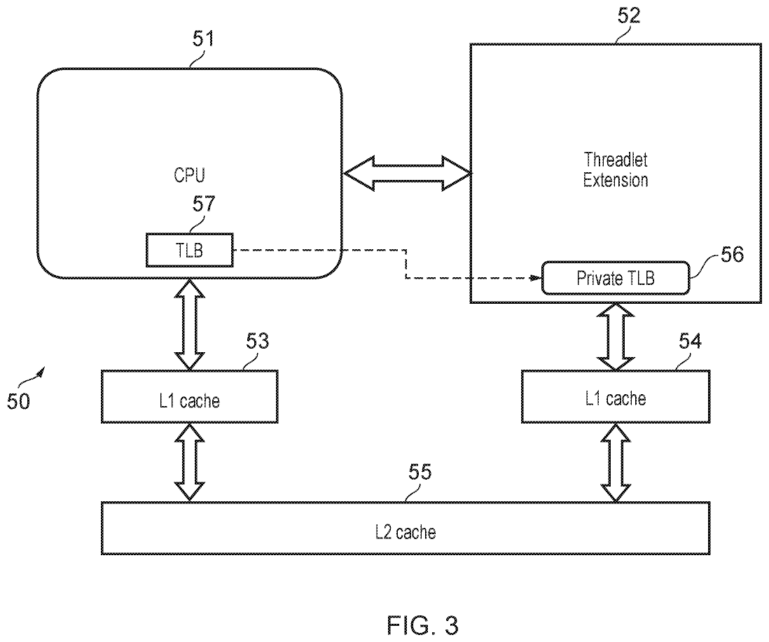

FIG. 3 schematically illustrates a data processing apparatus which may embody various examples of the present techniques;

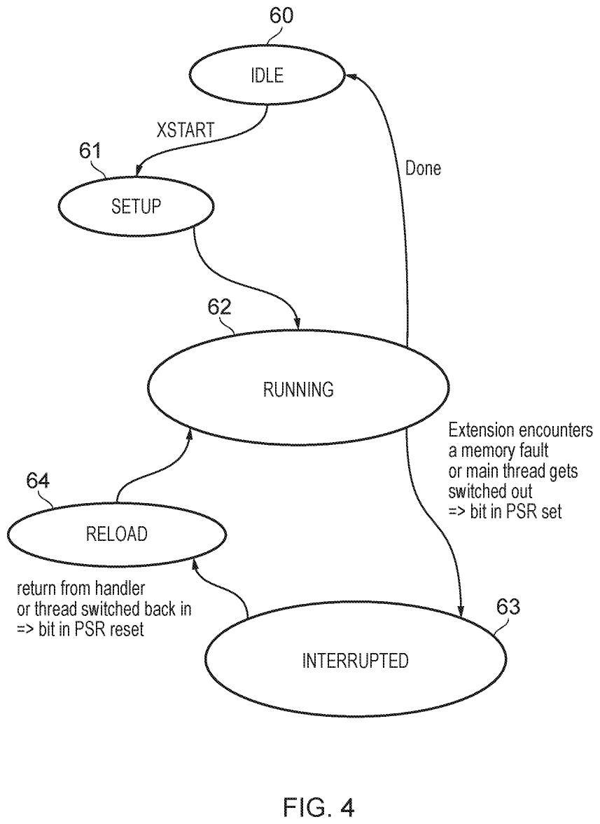

FIG. 4 is a state diagram illustrating an example set of states between which extension processing circuitry of the present techniques may transition;

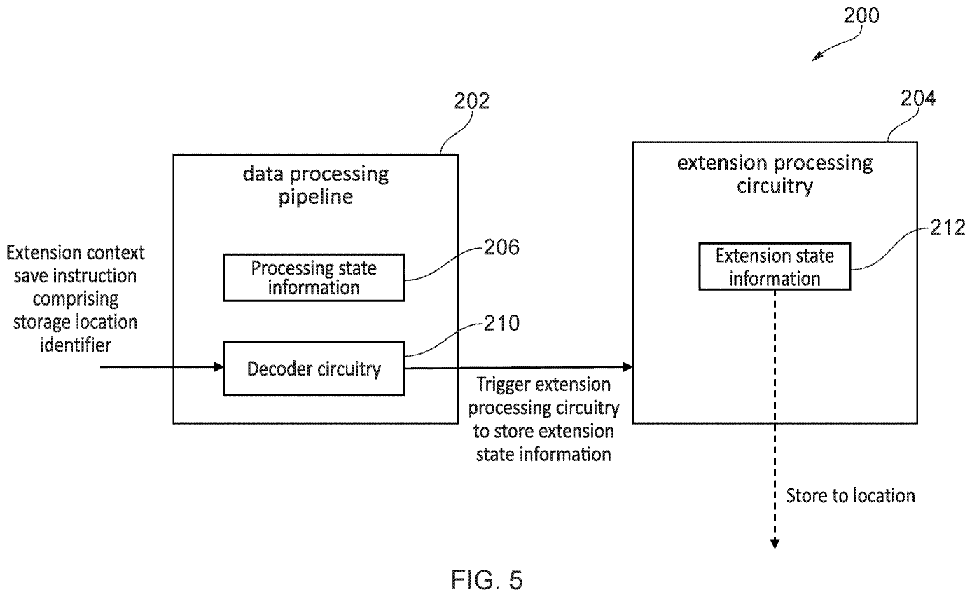

FIG. 5 schematically illustrates an apparatus according to various configurations of the present techniques;

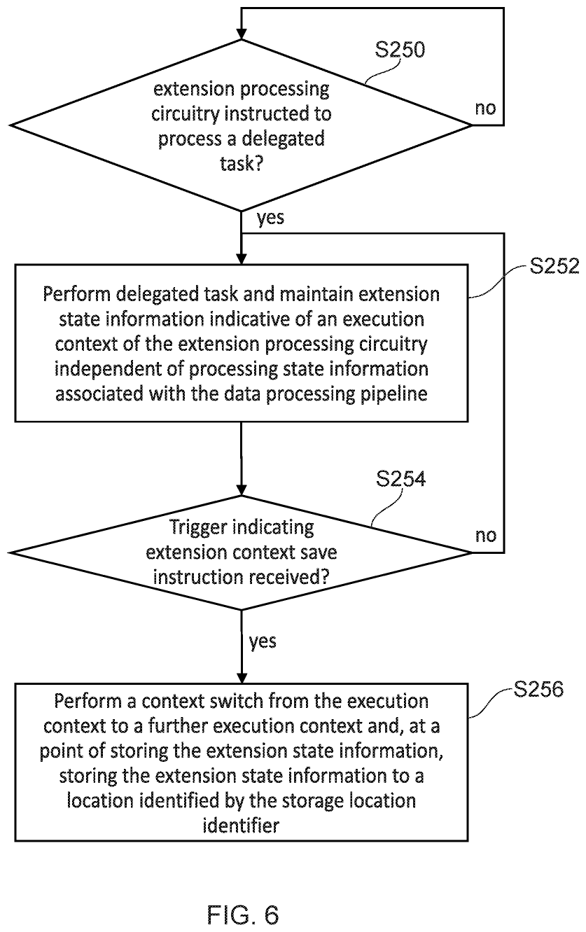

FIG. 6 schematically illustrates a sequence of steps taken by an apparatus according to various configurations of the present techniques;

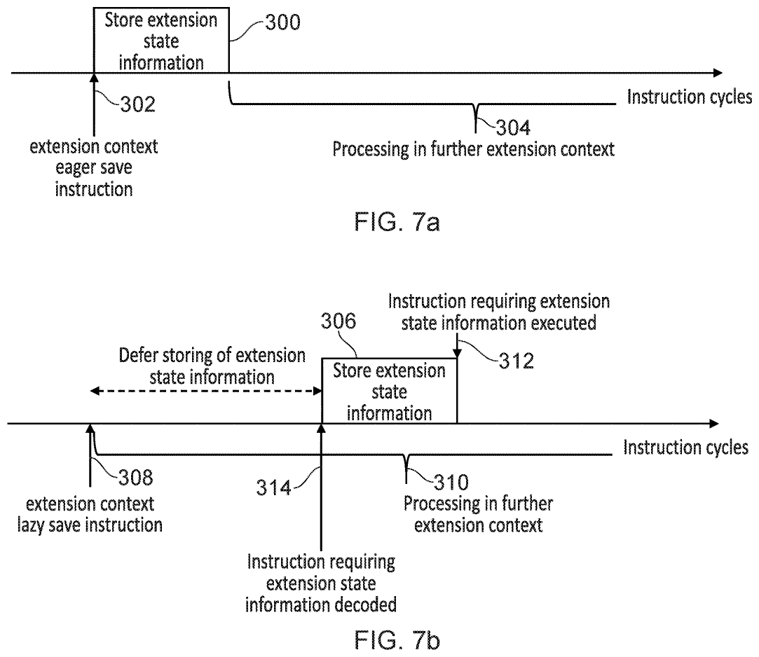

FIGS. 7a and 7b schematically illustrates an extension context eager save instruction and an extension context lazy save instruction according to various configurations of the present techniques;

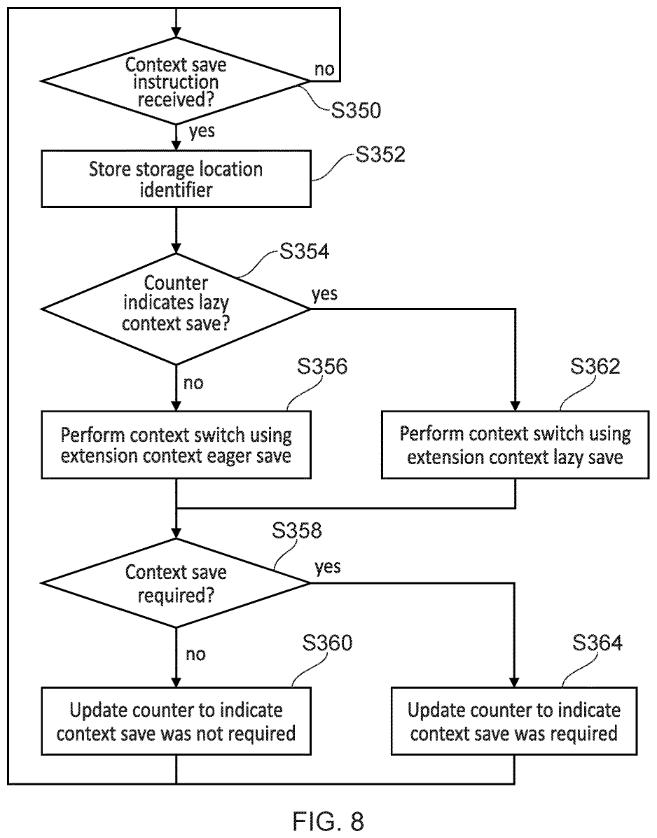

FIG. 8 schematically illustrates a sequence of steps taken by an apparatus according to various configurations of the present techniques;

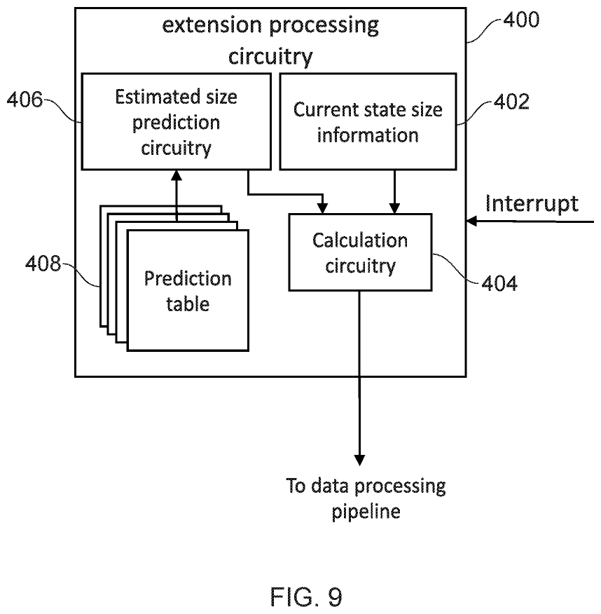

FIG. 9 schematically illustrates details of extension processing circuitry according to various configurations of the present techniques;

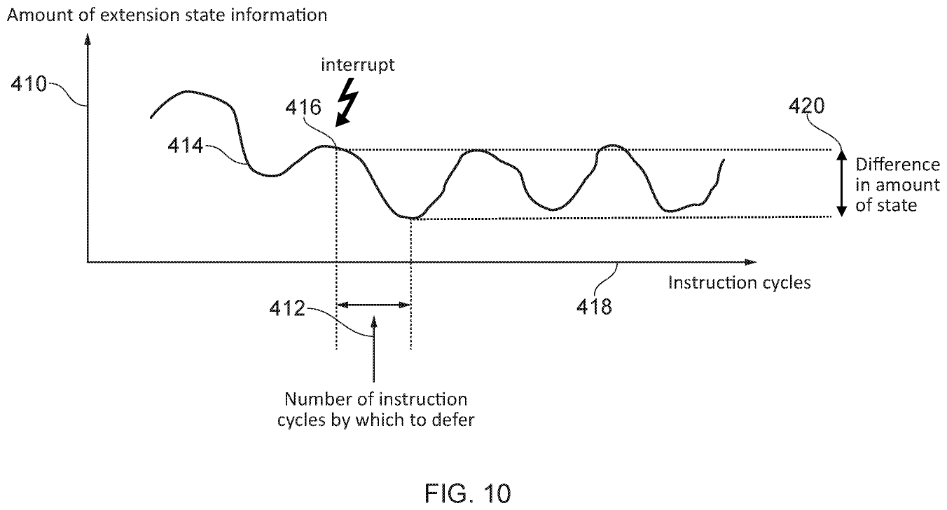

FIG. 10 schematically illustrates variation in an amount of extension state information according to various configurations of the present techniques;

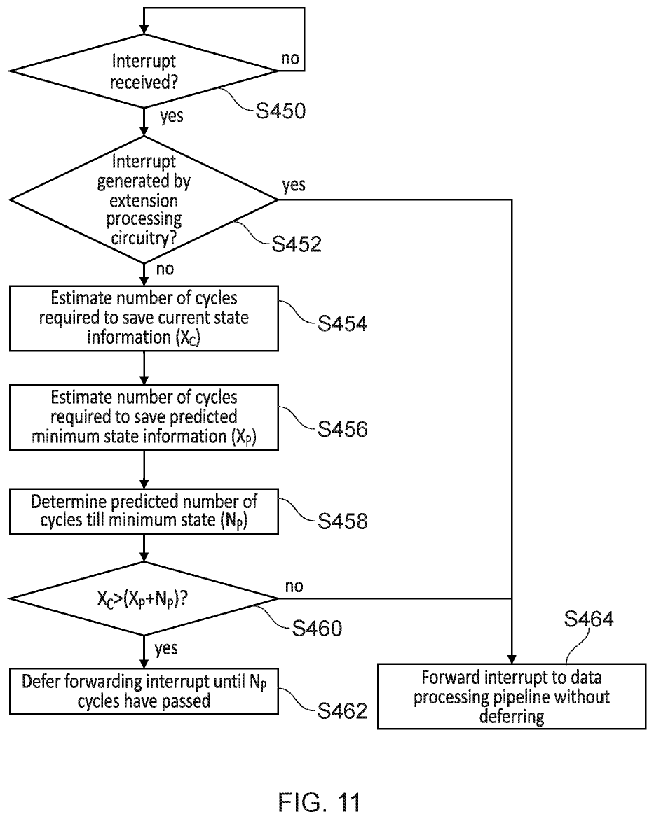

FIG. 11 schematically illustrates a sequence of steps carried out by an apparatus according to various configurations of the present techniques;

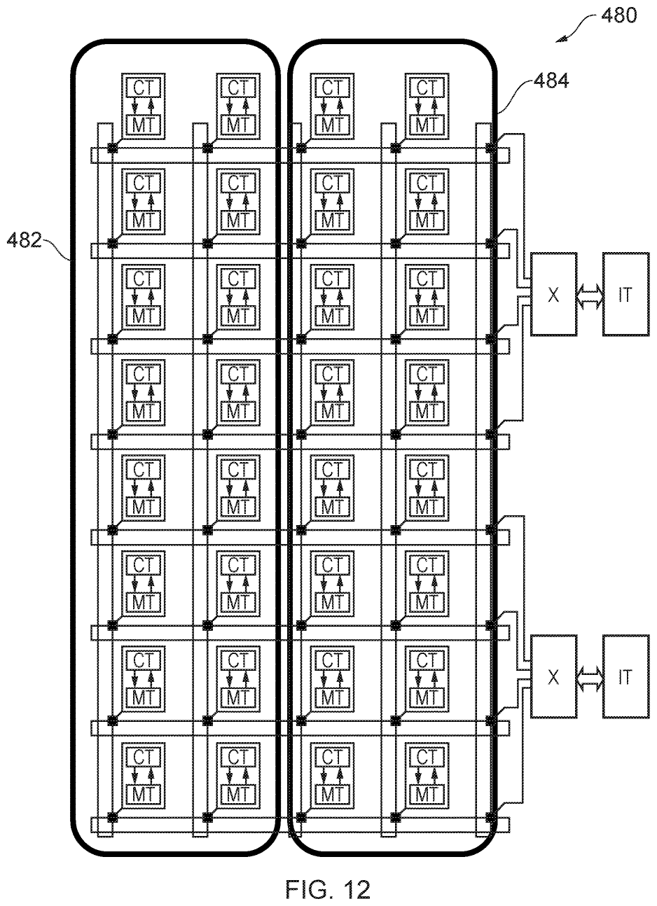

FIG. 12 schematically illustrates a layout of extension processing circuitry according to various configurations of the present techniques;

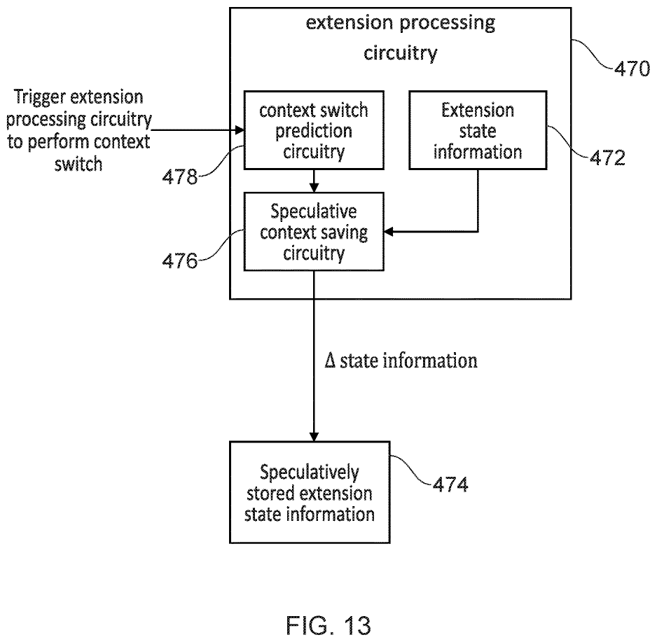

FIG. 13 schematically illustrates details of extension processing circuitry according to various configurations of the present techniques;

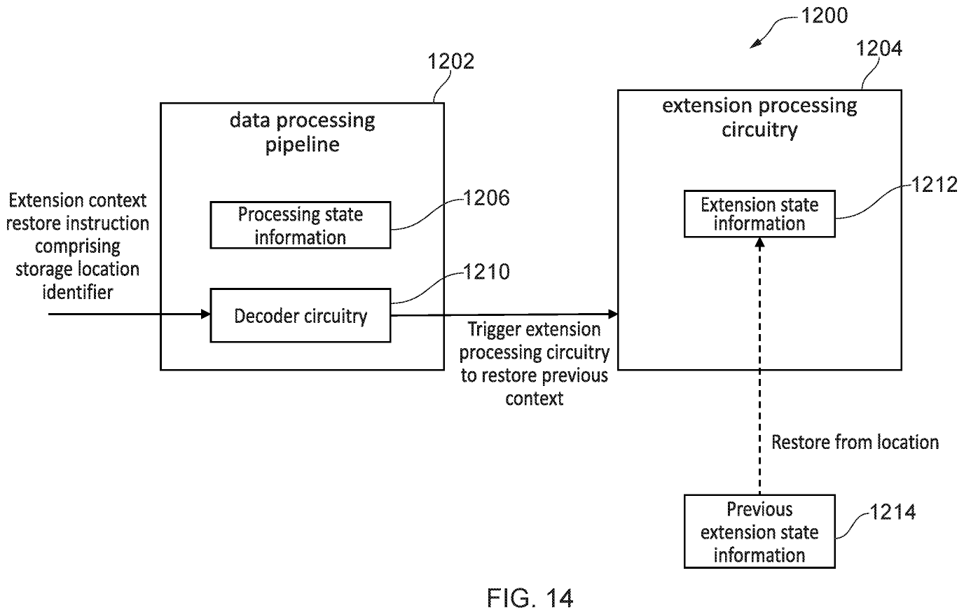

FIG. 14 schematically illustrates an apparatus according to various configurations of the present techniques;

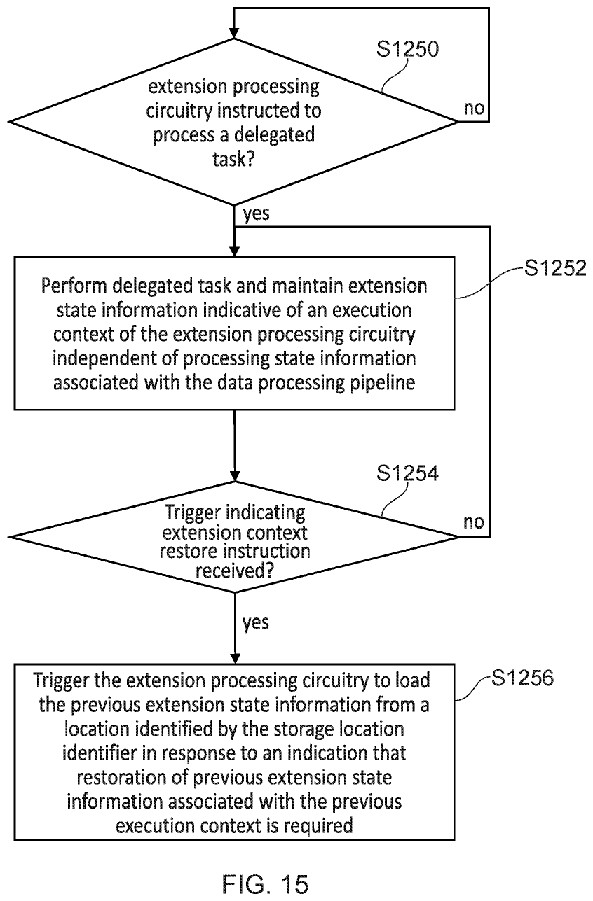

FIG. 15 schematically illustrates a sequence of steps taken by an apparatus according to various configurations of the present techniques; and

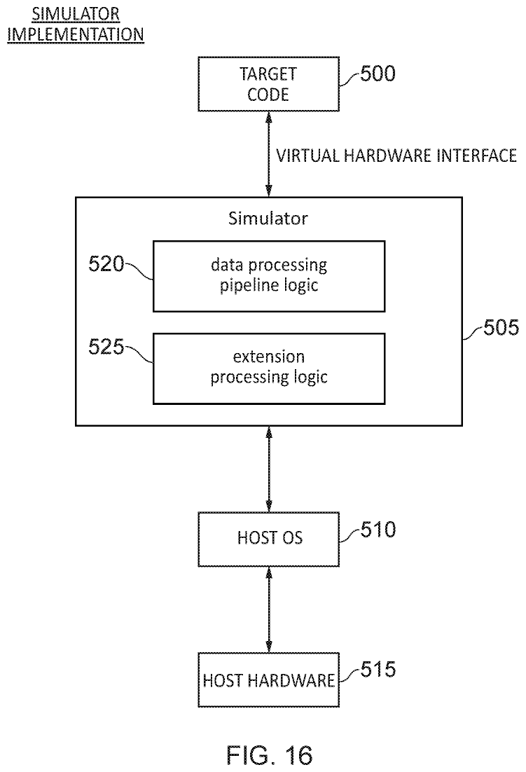

FIG. 16 schematically illustrates a simulator implementation according to some example configurations of the present techniques.

Apparatuses provided with data processing pipelines may be required to perform a variety of different processing operations in response to sequences of instructions. Such data processing pipelines may operate either in-order or out-of-order. Regardless as to the specific configuration of those pipelines, some sequences of instructions may require the data processing pipeline to perform one or more delegated tasks, for example, execution of one or more functions that are not part of the critical instruction path for that sequence of instructions. These delegated tasks may be time consuming and result in an overall reduction in processing efficiency if performed by the data processing pipeline. One approach to reducing the overheads associated with such functions is to provide extension processing circuitry which is available to the data processing pipeline and provides some processing function which can be used, by the data processing pipeline, to perform the delegated tasks.

The data processing pipeline is therefore able to delegate or offload functions to the extension processing circuitry, optionally including any required operands that are present in the registers of the data processing pipeline. The extension processing circuitry receives an indication of the delegated function and the required operands (if any are present) and, from that point on, performs the delegated task asynchronously to the data processing pipeline. Whilst the extension processing circuitry is processing the delegated function, the data processing pipeline is able to continue executing further instructions of the sequence of instructions and may be provided with one or more instructions to check on the progress of the extension processing circuitry and to import any results that may be generated by the extension processing circuitry into registers comprised in the data processing pipeline.

Because the data processing pipeline and the extension processing circuitry operate asynchronously to one another, the extension processing circuitry may generate and maintain extension state information indicative of its own execution context. This additional state information provides an additional consideration during context switches which can impact on overall system performance.

According to some configurations there is provided an apparatus comprising a data processing pipeline for processing a sequence of instructions. The data processing pipeline comprises decoder circuitry responsive to receipt of instructions of the sequence of instructions to generate control signals to control the data processing pipeline to perform processing operations. The apparatus is also provided with extension processing circuitry responsive to identification, by the data processing pipeline, of a delegated task to perform the delegated task asynchronously to the data processing pipeline. The extension processing circuitry is configured to maintain extension state information indicative of an execution context of the extension processing circuitry independent of processing state information associated with the data processing pipeline. In addition, the decoder circuitry is responsive an extension context save instruction comprising a storage location identifier, at a point of storing the extension state information, to store the extension state information to a location identified by the storage location identifier.

The extension processing circuitry is configured to generate and maintain its own extension state information. The extension state information is generated and maintained asynchronously from the processing state information that is generated and maintained by the data processing pipeline. The extension state information comprises information associated with the delegated task that is generated or used as part of performing the delegated task. For example, the extension state information may include values stored in data registers of the extension processing circuitry and/or control registers associated with the delegated task. During a context switch the extension state information associated with a current context may be stored so that it can be restored and processing can be resumed at a subsequent point.

Whilst the data processing pipeline and the extension processing circuitry each generate and maintain their own state information indicative of their execution context, the execution context of the extension processing circuitry is associated with the execution context of the data processing pipeline. Specifically, when a context switch occurs in the data processing pipeline, the operating system instructing the context switch should also instruct the extension processing circuitry to perform a context switch. There are several reasons for this requirement. First, the execution context of the extension processing circuitry may contain secure data that is owned by the execution context of the data processing pipeline that instructed the extension processing circuitry to perform the delegated task. Triggering the extension processing circuitry to perform a context switch when the data processing pipeline performs a context switch ensures that this sensitive data is not accessible by the data processing pipeline when the data processing pipeline is operating in a different execution context. Second, the data processing pipeline may require use of the extension processing circuitry in both execution contexts of the data processing pipeline (before and after the context switch). Allowing the extension processing circuitry to continue performing a delegated task that was instructed prior to the context switch could render the extension processing circuitry unavailable for receiving delegated tasks subsequent to the context switch reducing the efficiency of the apparatus subsequent to the context switch.

In general, a context switch is controlled by the operating system which instructs the data processing pipeline to perform the tasks of saving the current execution context so that it can be resumed at a later point and loading a new execution context. The extension processing circuitry may not be directly controlled by the operating system. Rather, the extension processing circuitry operates to perform the delegated task instructed by the data processing pipeline with little or no further communication with the data processing pipeline once the task has been instructed. Because the extension processing circuitry and the data processing pipeline are operating asynchronously to one another, the data processing pipeline does not have direct oversight of what instructions are executed by the extension processing circuitry at any point. The apparatus is therefore provided with an extension context save instruction and the extension context save instruction may be configured to trigger a context switch in the extension processing circuitry. The extension context save instruction belongs to the instruction set architecture (ISA) used by the data processing pipeline. The instruction set architecture defines a complete set of instructions that can be used by a programmer/compiler to interact with the data processing pipeline. Such instructions are provided as part of a sequence of instructions that are interpreted by decoder circuitry in the data processing pipeline which receives the instructions and, based on those instructions, triggers processing circuitry of the pipeline to perform the defined operations.

In some configurations therefore, the decoder circuitry is further responsive to the extension context save instruction comprising the storage location identifier to trigger the extension processing circuitry to perform a context switch from the execution context to a further execution context.

In the case of the extension context save instruction, the data processing pipeline may be responsive to the instruction to trigger the context switch in the extension processing circuitry. For example, the apparatus may be provided with a dedicated communication path between the data processing pipeline and the extension processing pipeline which can be used to trigger (signal) the context switch to the extension processing circuitry. The extension context save instruction includes a storage location identifier which is passed to the extension processing circuitry by the decoder circuitry on receipt of the extension context save instruction (for example, through the dedicated communication path between the data processing pipeline and the extension processing circuitry) which defines a location to be used in the event that storage of the extension context information is required.

Advantageously, the extension context save instruction provides the operating system with the ability to manage the extension state information generated by the extension processing circuitry and, hence, allows greater control over the saving of state information during a context switch.

The different circuit elements set out herein (for example, the extension processing circuitry and the data processing pipeline) may be provided as discrete blocks of circuitry each providing the function of one of those different circuit elements. Alternatively, the different circuit elements may be provided as one or more blocks of circuitry that together provide the functions described in relation to those different circuit elements.

In some configurations the data processing pipeline comprises a set of registers for holding data values on which the data processing operations are performed and when the delegated task is dependent on one or more data values stored in a corresponding one or more registers of the set of registers, the data processing pipeline is configured to transfer the one or more data values from the corresponding one or more registers to the extension processing circuitry in association with the identification of the delegated task. In some configurations the transfer is via a dedicated communication path between the data processing pipeline and the extension processing circuitry. The dedicated communication path provides a communication pathway between the data processing pipeline and the extension processing circuitry that, in some configurations, is independent of the memory hierarchy and may be distinct from any cache structures associated with the data processing pipeline and/or the extension processing circuitry. In some configurations, the dedicated transfer path may be provided with a dedicated transfer buffer to store the one or more data values during transfer from the data processing pipeline to the extension processing circuitry.

In some configurations the decoder circuitry is responsive to the extension context save instruction specifying an extension context eager save, to generate extension context eager save control signals; and the extension processing circuitry is responsive to the extension context eager save control signals to store the extension state information to the location independent of whether the extension state information is predicted to be modified by the extension processing circuitry whilst operating in the further execution context. The extension context eager save instruction can therefore be used to enforce the saving of the extension state information as part of the context switch. Performing an eager (i.e., at the point at which the context switch is performed) save of the extension state information means that latencies associated with saving this data can potentially be hidden amongst operations associated with the context switch, for example, the saving of the processing context information maintained by the data processing pipeline.

At the point of saving the extension state information in response to an extension context eager save instruction, the extension processing element may not have any information to determine whether or not such a save would be necessary. For example, the extension processing circuitry may not be used by the data processing pipeline in the further execution context and no attempts to access or make modifications to the state information may be made before the extension processing circuitry is instructed to switch back to the initial execution context. In some configurations the extension processing circuitry is responsive to the eager context save control signals, to retain the extension state information and to maintain modification information indicative of whether the extension state information is modified prior to a further context switch from the further execution context back to the execution context. The modification information can be used to determine, at a time of switching from the further execution context back to the execution context, whether or not the retained extension state information is the same as the saved extension state information. If the retained and saved extension state information are the same, then the extension processing circuitry can omit loading of the saved extension state information (for example, in response to an extension context restore instruction as described below) resulting in a reduced latency. However, where the modification information indicates that the retained execution state has been modified whilst operating in the further execution context, then at the time of performing the further context switch, the extension processing circuitry can load the saved execution state (for example, in response to an extension context restore instruction as described below). This combination of eager saving of extension state information and only reloading the extension state information in the event that the retained execution state is modified, provides the advantage of enabling the latency associated with the save to be hidden and eliminates the need to load the extension state information every time there is a return to a previous extension context. The modification information stores an indication as to whether the extension state information has been modified. Such a modification may occur whenever the extension processing circuitry makes any attempt to access (e.g. to read or write) the extension state information whilst operating in the further execution context. This is because the extension state information may contain secure information that should only be accessed by the extension processing circuitry when operating in the execution context associated with that extension state information. The extension processing circuitry may therefore be responsive to any attempt to access the extension state information whilst operating in the further execution context, to defer the attempt to access the extension state information until the extension state information has been replaced (overwritten) either by the extension state information associated with the further execution context or default extension state information.

The performance of a context switch by the extension processing circuitry does not always necessitate that the extension context information is stored and, if it is stored, the act of storing the extension context information may be deferred until a later point. In some configurations the decoder circuitry is responsive to the extension context save instruction specifying an extension context lazy save, to generate extension context lazy save control signals; and the extension processing circuitry is responsive to the extension context lazy save control signals to defer storing the extension state information until a point at which it is determined that a further delegated task associated with the further execution context requires the extension processing circuitry to access the extension state information. In a case where the extension processing circuitry, whilst operating in the further extension context, is not required to access the extension state information, then by deferring the storing of the extension state information, the extension processing circuitry is able to avoid latencies associated with storing the extension state information. In such a case, there is also no need to restore the extension state information in response to a further context switch that causes the extension processing circuitry to return to the initial execution context.

In some configurations the extension processing circuitry is configured to: store the storage location identifier to a secure region of storage; and at the point at which it is determined that the further delegated task requires the extension processing circuitry to modify the extension state information, to retrieve the storage location identifier from the secure region of storage and store the extension state information to the location identified by the storage location identifier. The storage location identifier identifies a region of memory to which the extension state information is stored. The provision of this information to applications running on the processing element may represent a security risk as it could allow a location of sensitive information to be determined by those applications. Hence, the provision of a secure storage region which is inaccessible to applications running on the extension processing circuitry provides increased security.

Whilst in the configurations described hereinabove multiple variants of the extension context save instruction were provided, i.e., the extension context lazy save instruction and the extension context eager save instruction, in some configurations the extension processing circuitry is configured to maintain an indication of a likelihood that the extension state information will be modified by the further execution context, and to determine whether to perform an extension context lazy save or an extension context eager save dependent on the indication. The extension context save instruction can therefore be provided as a single instruction with the type of extension context save determined based on a value of the indication, rather than being specified in the instruction. The indication may be implemented as a modifiable value, and indeed may be implemented as a counter. Such a counter may be implemented as a saturating counter that is modified in a first direction (e.g., increased) when it is determined that storage of the extension state information was required and that is modified in a second direction (e.g., decreased) when it is determined that storage of the extension state information was not required. The determination as to whether to perform the extension context lazy save of the extension context eager save may then be determined from a value of the indication. For example, if the indication value is above a threshold then it may be determined that, during recent operation, the storage of the extension state information was more likely to be required, then the extension processing circuitry could implement the extension context save instruction as an extension context eager save instruction. Similarly if the indication value is below or equal to the threshold, then the extension processing circuitry could implement the extension context save instruction as an extension context lazy save instruction. In some configurations, the extension context save instruction may be implemented having multiple variants including the extension context lazy save instruction, the extension context eager save instruction, and a further extension context save instruction in which the extension context save type is dependent on a value of the indication.

As discussed, by choosing whether or not to defer the storage of extension state information, the latency associated with a context switch can be managed. These techniques can be implemented through the use of the extension context save instructions under the control of the operating system. Overall control of the scheduling of a context switch is handled by the operating system. However, there are instances in which an operating system may be required to make an unscheduled context switch, for example, in response to an interrupt. If an interrupt is received at a time when a size of the extension state information is unusually large, the interrupt can result in a high latency associated with storing that extension state information. In some configurations the extension processing circuitry is configured to receive an indication of an interrupt intended for the data processing pipeline, and to perform a determination of whether to defer the interrupt based on current state size information indicative of a size of the extension state information. As discussed, the storing of the extension state information is controlled by the issuing of the extension state save instruction to the data processing pipeline which may be used, for example, by an operating system as part of a context switch. The operating system may issue the extension state save instruction in response to receipt of the interrupt resulting in the storage of the extension state information. The inventors have realised that the total latency associated with saving the extension state information may be reduced if the interrupt is intercepted by the extension processing circuitry and deferred dependent on the size of the extension state information. The determination as to whether to defer the interrupt may be based on various criteria. In some configurations the determination of whether to defer is based on one or more of: a latency consideration; a power consumption consideration; a fair usage policy; and an estimate of a memory bandwidth usage. For example, the extension state processing circuitry may determine that the total power, latency, bandwidth, etc. associated with storing the extension state information is above a threshold and may choose to defer the storage of the extension state information until the size of the extension state information is below a threshold.

In some configurations the extension processing circuitry comprises extension state size prediction circuitry configured to determine predicted future state size information indicative of a predicted future size of the extension state information; and the extension processing circuitry is configured to perform the determination of whether to defer based on a comparison between the current state size information and the predicted future state size information. Where the predicted future state size information is lower than the current state size information it may be beneficial to defer the interrupt in order to reduce the latency, power consumption, and/or memory bandwidth associated with storing the extension state information, and/or to ensure that a fair usage criterion is met. In some configurations the extension processing circuitry may be configured to defer storing if the predicted future size is less than a predefined fraction of the current state size information. In further configurations, the extension processing circuitry may be configured to defer storing if the predicted future size is less than a predefined threshold and/or if the current state size is greater than a predefined threshold.

In some configurations the predicted future state size information comprises an indication of a predicted minimum extension state size and a predicted number of cycles until the extension state information reaches the predicted minimum extension state size. The predicted minimum extension state size may be a local minimum extension state size and, in some configurations, is a next predicted occurrence of a local minimum. The decision as to whether to defer the interrupt can be based on both the predicted minimum extension state size and the predicted number of cycles. In some configurations where the extension processing circuitry may base the decision as to whether to defer the interrupt on whether the predicted number of cycles until the extension state information reaches the minimum extension state size is above a predefined threshold. In some configurations, the extension processing circuitry may base the decision on whether each of the predicted number of cycles meets a first threshold and whether a difference between the current state size and the predicted minimum extension state size meets a second threshold.

In some configurations the extension processing circuitry is configured to: calculate a current save cost estimating a number of cycles required to save the state information based on the current state size information; calculate a deferred save cost estimating a number of cycles required to save the state information based on the predicted minimum extension state size and the predicted number of cycles; and determine to defer the interrupt based on a comparison of the deferred save cost and the current save cost. For example this may be based on the predicted minimum extension state size added to the predicted number of cycles, and the determination to defer the interrupt may occur when the deferred save cost is less than the current save cost. In this way the extension processing circuitry is able to select an action (whether to defer or not) that results in the smaller overall latency and, hence, is able to reduce the overall latency associated with interrupt handling.

The determination of the predicted minimum extension state size may be performed using any type of prediction circuitry known to the skilled person. In some configurations the extension state size prediction circuitry comprises a plurality of prediction tables, each of the one or more prediction tables comprising entries indexed based on an extension progress indicator, and each of the entries identifying corresponding state size information for a corresponding extension progress indicator value. The tables may be indexed based on a hash of the extension progress indicator. In some configurations different ones of the plurality of prediction tables may be indexed using a hash of one or more different sized portions of the extension progress indicator with the predicted minimum extension state size being determined from a table of the plurality of tables in which a largest corresponding portion of the extension progress indicator resulted in a hit. In some configurations, the predicted minimum extension state size and the predicted number of cycles may both be determined using the extension state size prediction circuitry. In some examples, as an alternative to the prediction tables, the extension state size prediction circuitry statically determines and preloads the predicted minimum extension state size (e.g. based on analysis of the code).

The form of the circuitry provided in the extension processing circuitry may vary dependent on the implementation requirements. For example, the extension processing circuitry may comprise a reduced data processing pipeline capable of performing a subset of the functions of the data processing pipeline. Alternatively, the extension processing circuitry may comprises one or more particular functional units capable of performing specific functions efficiently and asynchronously from the data processing pipeline. In some configurations the extension processing circuitry is arranged in a distributed architecture comprising a plurality of processing elements, which may be connected to one another via a network; and the extension state information comprises processing element state information indicative of a state of each of the plurality of processing elements. The processing elements of the distributed architecture may comprise a set of identical processing elements arranged to perform the same task repeatedly in parallel. Alternatively, or in addition, some of the processing elements may be configured to perform specific sub-tasks with different ones of the processing elements performing different portions of the delegated task. In this way, the extension processing circuitry is able to distribute the delegated task spatially across the distributed elements.

In some configurations each processing element of the processing elements is configured to store an active state indication identifying whether the processing element state information associated with that processing element is modified processing element state information or non-modified processing element state information; and the extension processing circuitry is configured to calculate the size of the extension state information based on a number of processing elements for which the active state information indicates that the state of that processing element is modified processing element state information. Determining a precise measure of the size of state information that needs to be saved may be computationally demanding and require precise monitoring of each individually modifiable storage element that comprises the extension processing state. The inventors have realised that, for a distributed architecture, the total amount of extension state information can be estimated from an indication as to which processing elements of the distributed architecture are active (and hence have associated extension state information) and which processing elements are inactive (and hence have no associated extension state information). In some configurations, each of the processing elements is provided with an active state flag indicative as to whether that processing element is active and, hence, has associated state information. In such configurations, the size of the extension state information is then calculated by summing the processing elements for which the active state flag indicates that the processing element is active. Calculating the size of the extension state information on this basis provides an efficient way to estimate extension state size.

In some configurations the plurality of processing elements are grouped into a plurality of processing element groups; and the extension processing circuitry is configured to trigger timing of the storage of the processing element state information independently for each of the plurality of processing element groups. The storage of the extension state information may require transfer of a relatively large amount of data to storage which can have a high latency associated with it. By triggering the timing of the storage independently for each of the processing element groups, this latency can be managed to reduce the immediate demand on the memory bandwidth associated with the storage.

In some configurations the extension processing circuitry is configured to trigger the storage of the processing element state information associated with each of the plurality of processing elements belonging to a first group of the plurality of processing element groups, and to cause each of the plurality of processing elements belonging to a second group to perform processing in one of the processing context and the further processing context. In other words, the extension processing circuitry is able to perform storage of extension state information associated with the first group whilst processing is either continued in the original execution context for the second group or whilst the second group begins processing in the further processing context. Where computations of the distributed architecture are unrolled in space, data associated with a subset of the delegated task may pass in a processing sequence through different processing elements as the computation progresses. By performing storage associated with processing elements that occur towards the beginning of the processing sequence in advance of those that occur later in the processing sequence, processing associated with the delegated task may be continued whilst the storage of extension state information is performed, thus, enabling processing and storage of extension state information to be overlapped reducing the observed latency associated with the context switch.

In some configurations the extension processing circuitry is configured to cause each of the plurality of processing elements belonging to the second group to perform processing in the processing context, and the extension processing circuitry is configured to cause each of the plurality of processing elements belonging to a third group to perform processing in the further processing context. During the context switch the extension processing circuitry may have, at a given time, three different groups of processing elements performing different operations (processing in the processing context, storing extension state information, and processing in the further processing context. During the context switch the size of the different groups may dynamically vary. For example, as storage of the extension state information of processing elements in the first group is completed, those processing elements may move to the third group and processing elements from the second group may be moved into the second group so that the extension state information associated with those proceeding elements can be saved.

In addition to the above described techniques for reducing latency associated with storage of extension state information, in some configurations the extension processing circuitry is configured to trigger the timing for each of the plurality of processing element groups sequentially. In other words, the extension processing circuitry is configured to sequentially work through at least the active processing elements (for example, indicated by an active state flag associated with each processing element), saving state associated with those processing elements (and resetting the active state flag) and, subsequently, beginning processing in the further extension context.

In some configurations the extension processing circuitry comprises: speculative context saving circuitry configured to perform a speculative context store of at least a portion of the extension state information in response to a prediction that the probability of occurrence of the context switch is above a predetermined threshold. The extension processing circuitry may comprise context switch prediction circuitry configured to generate the prediction of the probability of occurrence of the context switch. The prediction may be based on periodic elapse of a predefined period. The prediction may be based on occurrence of a local minimum extension state size. The prediction circuitry may comprise prediction circuitry based on one or more prediction tables which may be indexed based on at least a portion of an extension progress indicator (e.g., indexed using a hash generated from at least a portion of the progress indicator) and contain an indication of the probability (likelihood) that a context switch is going to occur. Alternatively, the context switch prediction circuitry could maintain one or more indicators of a number of cycles that have occurred between one or more recent pairs of context switches. For example, a set of N counters could be provided indicating the number of cycles that occurred between the last N context switches and the context switch prediction circuitry may predict the probability of occurrence of the context switch from a current number of cycles since the last context switch and the values of the N counters. Regardless as to the precise nature of the prediction circuitry, the speculative context saving circuitry is responsive to the likelihood of a context switch being above a predefined threshold to store at least a portion of the extension state information. The portion may comprise all the extension state information. By speculatively saving the portion of the extension state information, the latency associated with saving state information can be distributed (and, thus, at least partially hidden) across a larger number of cycles. When the context switch has been correctly predicted, this approach may reduce or eliminate the need to save any extension state information at the point of the context switch.

In some configurations the context switch prediction circuitry is configured to calculate the probability of occurrence of the context switch periodically. For example, the probability may be calculated with a period of a predetermined number of cycles. Alternatively, or in addition, the context switch prediction circuitry may be configured to predict the number of cycles until a context switch is predicted to occur and, based on a current size of the extension state information, a number of cycles required to store the extension state information. The predicted number of cycles may be updated periodically. In this way, the speculative context saving circuitry can begin storing the extension state information such that a predefined portion of the extension state information is stored at the point of the predicted context switch. For example, the speculative context saving circuitry may, dependent on a confidence of the timing of the predicted context switch speculatively save, in advance of the point of the predicted context switch, all of the extension state information (where the confidence is high), half of the extension state information (where the confidence is less high) or a quarter of the extension state information (where the confidence is low). It would be readily apparent to the skilled person that these fractions of the extension state information are provided by way of example only and that other fractions may be provided. Alternatively, in some configurations, the rate at which the extension state information is stored may be dependent on the confidence of the timing.

Speculatively saving the extension state information may reduce latency associated with the context switch but can require the extension state information to be resaved, for example, if the extension state information is modified by the extension processing circuitry between the point at which the speculative save is performed and the point at which the context switch occurs. In some configurations the speculative context saving circuitry is configured to maintain information indicative of the speculatively stored extension state information; and the extension processing circuitry is responsive, at a point of resolution of the speculative context store, to a determination that the speculatively stored extension state information is different from the extension state information, to update the speculatively stored extension state information based on a difference between the speculatively stored extension state information and the extension state information. In other words, the speculative context saving circuitry is configured to store a delta indicative of which parts of the extension state information have been modified by the extension processing circuitry between the speculative save and the context switch. The delta may be variously defined and may, in some configurations, provide an indication as to which elements of the extension state information have been stored, e.g., which registers of the extension processing circuitry have been modified. Alternatively, the delta may provide a much more coarse grained indication as to which portions of the extension state information have been modified. For example, the speculative context saving circuitry may group the extension state information into a plurality of high level groups and store, as the delta, an indication as to which of those groups have been modified.

In some configurations the extension processing circuitry is configured to store at least some of the extension state information at a same time as the data processing pipeline stores at least some of the processing state information. The storage of the extension state information can therefore be interleaved with the storing of the processing state information enabling latency associated with the storing to be hidden amongst the latency associated with storing the processing state information.

The extension state information may be stored without compression. Alternatively, in some configurations the extension processing circuitry is configured to compress the extension state information prior to storing. The compression may be performed by the extension processing circuitry and may comprise any compression algorithm known to the skilled person. In some configurations, the extension processing circuitry may be configured to determine whether or not to apply one or more compression algorithms to the extension state information based on a current size of the extension state information. In some configurations the extension processing circuitry may be configured to calculate whether or not to perform compression by estimating a compression store time to perform the compression and storing of the compressed extension state information, and an estimating an uncompressed store time to perform storing of the uncompressed extension state information. In this way, the extension processing circuitry can determine to perform compression when the compression store time is less than the uncompressed store time. For configurations in which the extension state information is stored speculatively, either one or both of the speculative extension state information and the delta may be compressed.

In some configurations there is provided an apparatus comprising a data processing pipeline for processing a sequence of instructions. The data processing pipeline comprises decoder circuitry responsive to receipt of instructions of the sequence of instructions to generate control signals to control the data processing pipeline to perform processing operations. The apparatus also comprises extension processing circuitry responsive to identification, by the data processing pipeline, of a delegated task to perform the delegated task asynchronously to the data processing pipeline. The extension processing circuitry is configured to maintain extension state information indicative of an execution context of the extension processing circuitry independent of processing state information associated with the data processing pipeline. The decoder logic is responsive to an extension context restore instruction comprising a storage location identifier, to trigger the extension processing logic to, in response to an indication that restoration of previous extension state information associated with the previous execution context is required, to load the previous extension state information from a location identified by the storage location identifier

The extension context restore instruction is an instruction of the instruction set architecture. In some configurations the apparatus is responsive to both the extension context save instruction described above and the extension context restore instruction. The extension context restore instruction provides the operating system with further control over the execution context of the extension processing circuitry. Whether or not the restoration of the previous extension state information is required may be determined in a variety of ways. In some configurations the determination is based on the extension context restore instruction. E.g., in some examples, the decoder circuitry is responsive to the extension context restore instruction specifying an extension context eager restore to generate extension context eager restore control signals; and the extension processing circuitry is responsive to the extension context eager restore control signals to load the previous extension state information from the location independent of whether the extension will be used or not by another context. In some configurations, the determination as to whether or not the restoration of the previous state is required is based on the extension state information usage by the extension processing circuitry. E.g., in some configurations the decoder circuitry is responsive to the extension context restore instruction specifying an extension context lazy restore, to generate extension context lazy restore control signals; and the extension processing circuitry is responsive to the extension context lazy restore control signals to determine whether current extension state information is the extension state information associated with the previous execution context and, if so, to omit restoration of the previous extension state information. In some configurations, the extension context save instruction and the extension context restore instruction may be provided as a single composite instruction which, when decoded by the decoder circuitry of the data processing pipeline, causes the extension processing circuitry to perform both saving (storage) of the execution state information and restoration of the previous extension state information.

In some configurations the extension processing circuitry comprises: context switch prediction circuitry configured to predict a probability of utilization of the extension processing circuitry prior to a next context switch; and speculative context loading circuitry configured to perform a speculative context load of at least a portion of the previous extension state information in response to a prediction, by the context switch prediction circuitry, that the probability of utilization of the extension processing circuitry meets a predetermined condition. The prediction of the probability of utilization may be determined using any prediction structure known to the skilled person. In some configurations, the prediction may be based on monitoring a frequency of usage of the extension processing circuitry during a current execution context and a prediction, by the context switch prediction circuitry, of a probability of occurrence of a next context switch as described above. For example, the context switch prediction circuitry may maintain a set of usage indicators or counters that record of a number of instruction cycles since the extension processing circuitry was last used and/or indicating a percentage of the instruction cycles over which the extension processing circuitry has been used. The predetermined condition may be a condition relating to the set of usage indicators or counters and/or an indication that a speculative context save has been triggered. In some configurations the predetermined condition is met when a speculative context save has been triggered and the usage indicator/counter recording a number of instruction cycles since the extension processing circuitry was last used exceeds a predetermined threshold.

Particular configurations will now be described with reference to the accompanying figures.

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values which are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to be impactful and ubiquitous for the data processing operations which this data processing apparatus 10 carries out. Example functions of this type have been found to include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The extension processing circuitry 23 is an example of a threadlet extension (TE) according to the present techniques. The sequence of operations it carries out to perform the defined function is referred to as a threadlet herein. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The directive or command sent to the extension processing circuitry 23 to initiate the delegated task is generated in response to an extension start instruction defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task can be returned to the register values via an extension synchronisation instruction.

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 is intended to represent an in-order processor, the data processing apparatus 30 is an out-of-order processor. As one consequence of this the data processing pipeline of the data processing apparatus 30 comprises a rename stage 35, allowing the data processing apparatus 30 to vary the order in which it executes instructions of the sequence of instructions, such that they can be executed in an order dictated by when their operands become available, and the availability of functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided an intermediary before results of their data processing are returned to the registers 37. A branch prediction unit 45 is also provided and its predictions inform the operation of the fetch stage 32.

The data processing apparatus 30 further comprises extension processing circuitry (“threadlet extension”) 49, which is provided to support efficient performance of one or more defined functions, which have been established to be impactful and ubiquitous for the data processing operations which this data processing apparatus 30 carries out. The extension processing circuitry 49 is closely associated with the data processing pipeline and is configured to perform the defined function in response to a delegation signal received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. The directive or command sent to the extension processing circuitry 49 to initiate the delegated task is generated in response to an extension start instruction defined for this purpose in the instruction set of the data processing pipeline. The close integration of the extension processing circuitry 49 with data processing pipeline also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task can be returned to the register values via an extension synchronisation instruction.

FIG. 3 schematically illustrates a data processing apparatus 50 according to some examples. This example provides a comparison to the examples of FIG. 1 and FIG. 2, in which examples the extension processing circuitry was closely embedded with the data processing pipeline, to the extent that those instances of extension processing circuitry may be considered to be within the CPU. In the example apparatus 50 of FIG. 3, the CPU 51 and the extension processing circuitry (threadlet extension) 52 are not as closely integrated. For example this is illustrated by the fact that each has its own path to memory, with an L1 cache 53 private to the CPU 51 and an L1 cache 54 private to the threadlet extension 52. They share the L2 cache 55. Nevertheless, the threadlet extension 52 remains tightly coupled to the CPU 51, and can be launched quickly when an extension start instruction is encountered in the CPU pipeline specifying the function this threadlet extension 52 performs. The threadlet extension 52 can get data directly from CPU registers at the start of its execution. Upon completion, it can return values via an extension synchronisation instruction. FIG. 3 also shows the threadlet extension 52 as having its own private TLB 56, in which it can cache currently used address translations. As a preparatory step before or associated with the delegation signal, content from the TLB 57 in the CPU 51 can be copied into the private TLB 56 in order to pre-warm this cache before the threadlet begins operation.

FIG. 4 is a state diagram illustrating an example set of states between which extension processing circuitry (TE) transitions in some examples. Initially the TE is in an IDLE state 60. When an extension start (XSTART) instruction is encountered by the data processing pipeline, a delegation signal can cause the TE to switch to the SETUP state 61. This may also require a signal indicating that the XSTART instruction has been committed to be asserted. In the SETUP state 61, certain actions necessary for preparing the TE can be performed, for example, in examples in which the TE has a separate path to memory (as in the case of FIG. 3), one setup task is the transfer of relevant entries currently in the CPU's TLB to a private TLB within the TE. This enables the TE to perform translations independently at a faster rate than if it were to rely entirely on the existing translation mechanism within the CPU. If the TE has been in a clock-gated or power-gated condition when in the IDLE state 60, the SETUP state 61 may also comprise the task of exiting the TE from that clock-gated or power-gated condition. Once the SETUP state 61 is complete the TE can switch to the RUNNING state 62. If the TE encounters a memory fault during its processing, it asserts a signal which will raise an interrupt within the CPU, causing it to stop executing the main thread and switch to a handler. The TE switches to the INTERRUPTED state 63. An indication of the source of the fault is placed in a special syndrome system register, the address associated with the fault is stored in the fault address system register, and a bit in the Program Status Register (PSR) will be set enabling the handler to quickly determine the source of the fault. Setting a bit in the PSR makes communicating the resumption of the threadlet straightforward, because the handler can reset the relevant bit in the SPSR and when the CPSR is restored from the SPSR during exception return, the TE can detect the resetting of this bit and resume executing. The TE will also switch to the INTERRUPTED state 63 if the main thread gets switched out, e.g. during a context-switch initiated by the operating system. In the INTERRUPTED state 63, the TE may be clock-gated or power-gated, unless some other thread launches a new command directed at it or the associated thread returns resumes execution or the handler returns. The TE returns from the INTERRUPTED state 63 to the RUNNING state 62 via the RELOAD state 64 in which any context or state relevant to its execution, which was previously saved to memory, can be restored. This might be the case if another thread made use of a TE which was previously interrupted. Finally, when the extension reaches the end of the offloaded granule of computation (the delegated task) it moves to the IDLE state 60. The TE will advertise completion of the task, so that an extension synchronisation instruction (XSYNC) can pick up that “done” signal and, if required, provide a return value to a specified register. If the TE has any lingering data in its private caches it might also need to flush these entries upon completion.

An example of using threadlets is now set out. The programmer or compiler identifies functions whose execution in custom hardware (extension processing circuitry) satisfies the cost-benefit thresholds in their use-case. An instruction (such as XSTART) is used to launches a command within the designated CPU extension. An example use written in pseudo-code (for such an identified function “funcX”) is as follows:

```
funcA ( ) {
  ...
  XSTART {x0 − x3}, #imm_op //funcX(a, b, c, d);
  I1
  I2
  I3
  I4
  ...
  XSYNC x0, #imm_op
  ...
}
```

Thus, within the function funcA, the XSTART instruction initializes the CPU extension and transfers to the extension processing circuitry the parameters (a, b, c, d) for funcX, which are in registers x0, x1, x2, x3 respectively. The XSTART instruction in this example also specifies the immediate value #imm_op, which defines the specific function to be carried out. For example, whilst there might only be one instance of extension processing circuitry, it may be capable of performing more than one function, or at least more than one variant of a function, and the immediate value #imm_op can select the desired variant and/or function. In other examples there may be more than one instance of extension processing circuitry and the immediate value #imm_op can select between them. Depending on the setup, the extension could also automatically get a copy of relevant entries in the TLB. The extension processing circuitry then carries out the task required (funcX) and during its execution, the CPU is free to carry on executing other instructions I1, I2, I3, I4, etc. At some point in the future, the CPU executes an extension synchronisation instruction (XSYNC) which automatically checks whether the extension has completed or not. If it has not, for some variants of the extension synchronisation instruction, the CPU will wait for the delegated task to complete. Other variants of the extension synchronisation instruction (e.g. the XSYNCS variant) allow the CPU can carry on executing other code (if there are alternative routines available or stop executing and wait for completion of the extension (typically if there is nothing else to execute in the interim). There are a range of variations of XSTART and XSYNC proposed herein, and these are discussed in more detail with reference to the figures which follow.

FIG. 5 schematically illustrates an apparatus 200 according to some configurations of the present technique. The apparatus 200 is provided with a data processing pipeline 202 for processing a sequence of instructions and extension processing circuitry 204. Both the data processing pipeline 202 and the extension processing circuitry 204 store state information. In particular, the data processing pipeline 202 stores processing state information 206 that is indicative of a processing context of the data processing pipeline 202. The extension processing circuitry 204 stores extension state information 212 indicative of an extension processing context of the extension processing circuitry 204. The data processing pipeline 202 comprises decoder circuitry 210 configured to receive a sequence of instructions and, in response to receiving the sequence of instructions, to control the data processing pipeline 202 to perform the sequence of processing operations. The decoder circuitry 210 is responsive to an extension context save instruction comprising a location identifier to trigger the extension processing circuitry 204 to store extension state information. In some examples, the extension context save instruction further causes the extension processing circuitry 204 to trigger the extension processing circuitry 204 to perform a context switch. In other examples, a context switch may be triggered by another mechanism (e.g. by a separate instruction from the extension context save instruction).

During a context switch, for example, from a current processing context to a further (different) processing context, the operating system triggers the data processing pipeline 202 to store the processing state information 206 so that, at a subsequent point, the processing state information 206 can be restored and the data processing pipeline 202 can continue processing from the point at which the processing state information 206 was saved. In addition, the operating system uses the extension context save instruction to trigger the extension processing circuitry 204 to store the extension state information 212 to a storage location so that, at the subsequent point (e.g., the point at which the data processing pipeline 202 continues processing), the extension state information 212 can be restored to the extension processing circuitry 204 and extension processing can be resumed.

FIG. 6 schematically illustrates a sequence of steps carried out by the apparatus 200 in accordance with various configurations of the present techniques. Flow begins at step S250 where it is determined if the extension processing circuitry 204 has been instructed to process a sequence of instructions. If no, then flow remains at step S250. If, at step S250, it was determined that the extension processing circuitry 204 has been instructed to process a delegated task then flow proceeds to step S252. At step S252 the extension processing circuitry 204 processes the delegated task asynchronously to the data processing pipeline 202 and maintains extension state information 212 indicative of an execution context of the extension processing circuitry 204. The extension state information 212 is generated and maintained by the extension processing circuitry 204 independent of the processing state information 206 that is maintained by the data processing pipeline 202. Flow then proceeds to step S254 where it is determined, by the extension processing circuitry 204, whether a context save has been triggered, for example, due to an extension context save instruction received by decoder circuitry 210 of the data processing pipeline 202 and the decoder circuitry 210 issuing a trigger for the extension processing circuitry 204 to perform a context switch. The trigger is associated with a location identifier indicating a location to be used for storage of the extension state information 212. If, at step S254, a trigger has not been received, then flow returns to step S252. If, at step S254, a trigger has been received then flow proceeds to step S256 where the extension processing circuitry 204 performs a context switch from the (current) execution context to a further execution context (different from the current execution context). The extension processing circuitry 204 is further configured, at a point of storing the extension state information 212, to store the extension state information 212 to a location identified by the storage location identifier.

FIGS. 7a and 7b schematically illustrates the storing of extension state information in accordance with some configurations of the present techniques. In particular, FIG. 7a illustrates the process of storing state information in response to an extension context eager save instruction received by decoder circuitry 210 of the data processing pipeline 202 and indicating a storage location identifier. The decoder circuitry 210 issues a trigger to the extension processing circuitry 204 to cause a context switch. In the illustrated example, a trigger associated with an extension context eager save instruction is received at a point 302 during the processing of the delegated task by the extension processing circuitry 204. The extension processing circuitry 204 responds to receipt of the trigger indicating the extension context eager save instruction to store 300 the extension state information 212 to the location identifier by the storage location identifier. The storage 300 of the extension state information 212 may take a number of instruction cycles dependent on the size of the extension state information 212 that is required to be stored by the extension processing circuitry 204. Once the extension state information 212 has been stored 300, the extension processing circuitry 204 is made available for processing in a further extension context 304.

FIG. 7b illustrates the processing of storing state information in response to an extension context lazy save instruction received by decoder circuitry 210 of the data processing pipeline 202 and indicating a storage location identifier. The decoder circuitry 210 issues a trigger to the extension processing circuitry 204 to cause a context switch. In the illustrated example, a trigger associated with an extension context lazy save instruction is received at a point 308 during the processing of the delegated task by the extension processing circuitry 204. The extension processing circuitry 204 responds to receipt of the trigger indicating the extension context lazy save instruction and performs a context switch to begin processing in the further extension context 310. The extension processing circuitry 204 is configured to defer storing 306 of the extension state information 212 until a point at which it is determined that the extension state information 212 is required by the further processing context. In the illustrated example, an instruction requiring the extension state information is decoded by extension decoder circuitry provided in the extension processing circuitry 204 at point 314. This is detected by the extension processing circuitry 204 which responds by storing 306 the extension state information 212 to the location identifier by the storage location identifier. The storage 306 of the extension state information 212 may take a number of instruction cycles dependent on the size of the extension state information 212 that is required to be stored by the extension processing circuitry 204. Once the extension state information 212 has been stored 306, the instruction requiring the extension state information 212 is executed and the extension processing circuitry 204 continues processing in the further extension context 310.

Whilst in the examples of FIGS. 7a and 7b a type of the context save (extension context eager save or extension context lazy save) was identified by the type of extension context save instruction received by the decoder circuitry, this is not always the case. FIG. 8 schematically illustrates a configuration in which the type of the context save is determined based on a counter indicating a history of whether a context save has been required or not during recent context switches. Flow begins at step S350 where it is determined if a context save instruction has been received. If, at step S350, it is determined that a context save instruction has not been received, then flow remains at step S350. If, at step S350, it is determined that a context save instruction has been received, then flow proceeds to step S352 where the storage location identifier included in the context save instruction is stored, for example, to secure storage in the extension processing circuitry 204. Flow then proceeds to step S354 where it is determined whether a current value of a counter indicates that the context save should be a lazy context save type. If, at step S354, it is determined that the counter indicates that a lazy context save should be performed, then flow proceeds to step S362, where the extension processing circuitry 204 is triggered to perform a context switch from an initial extension context to a further extension context using an extension context lazy save, for example, as described in relation to FIG. 7a. Flow then proceeds to step S358. If, at step S354, it was determined that the counter indicates that an extension context lazy save should not be performed, then flow proceeds to step S356 where a context switch from an initial extension context to a further extension context using an extension context eager save, for example, as described in relation to FIG. 7b, is performed before flow proceeds to step S358. At step S358 it is determined whether a context save was required during the initial extension context, i.e., the extension context prior to the context switch. If, at step S358, it is determined that a context save was required, then flow proceeds to step S364 where the counter is updated to indicate that a context save was required before flow returns to step S350. If, at step S358, it is determined that a context save was not required, then flow proceeds to step S360 where the counter is updated to indicate that a context save was not required before flow returns to step S350.

FIG. 9 schematically illustrates details of extension processing circuitry 400 according to some configurations of the present techniques. Extension processing circuitry 400 is arranged to store current state size information 402 providing an estimate of a current size of the extension state information. The extension processing circuitry 400 is also provided with calculation circuitry 404, estimated size prediction circuitry 406 and a plurality of prediction tables. The extension processing circuitry 400 is arranged to intercept an interrupt intended for the data processing pipeline and, using the calculation circuitry 404, to determine whether to immediately forward the interrupt to the data processing pipeline without waiting (deferring) or defer the interrupt for one or more instruction cycles. The estimated size prediction circuitry 406 is arranged to predict a future size of the extension state information. In the illustrated configuration, the estimated size prediction circuitry 406 bases the prediction on a lookup in one or more of a plurality of prediction tables 408. The lookup is based on an index of a current extension progress counter value indicative of a current instruction being executed by the extension processing circuitry 400. The estimated size prediction circuitry indexes into one or more of the plurality of prediction tables based on a hash of at least a portion of the extension progress counter. If the index hits in the one or more prediction tables 408, then an estimated minimum extension state size and an estimated number of instruction cycles until that minimum is reached is determined from the data stored in the entry of the table that resulted in the hit. The estimated size prediction circuitry 406 passes the estimated minimum extension state size and the estimated number of instruction cycles to the calculation circuitry 404 which also receives the current state size information 402. The calculation circuitry 404 performs a calculation to estimate a latency associated with storing extension state information having the current extension state size, and a calculation to estimate a latency associated with waiting the estimated number of instruction cycles before saving extension state information having the estimated minimum extension state size. If the calculation circuitry 404 determines that waiting the estimated number of instruction cycles will result in a reduced overall latency associated with saving the extension state information, then the calculation circuitry 404 triggers the extension processing circuitry 400 to defer the interrupt until the estimated number of instruction cycles has passed. If, on the other hand, the calculation circuitry 404 determines that waiting the estimated number of instruction cycles will not result in a reduced overall latency associated with saving the extension state information, then the calculation circuitry 404 triggers the extension state processing circuitry to forward the interrupt to the processing pipeline without waiting (i.e., without deferring the interrupt).

FIG. 10 schematically illustrates the variation in an amount of extension state information 414 on the Y axis 410 plotted against a number of instruction cycles on the X axis 418. In the illustrated example, the amount of state information 414 can be seen to vary with a number of local minima occurring. If the extension processing circuitry 400 is triggered to save the extension state information at those minima, the latency associated with saving the extension state information will be lower than if the extension processing circuitry 400 is triggered to save the extension state information at some point either immediately before or immediately after the minimum. In some cases, the amount of additional extension state information that needs to be saved (for example, at the maxima of the amount of extension state information), compared to the amount of extension state information that needs to be saved at the next minimum, may result in a greater latency than deferring the interrupt until the minimum is reached. For example, if an interrupt is received at the point 416 then the amount of extension state information is at a local maxima resulting in additional latency associated with saving the additional extension state information 420 compared to the amount of extension state information that would have to be stored at the next minimum. Using the estimated size prediction circuitry 406, the extension processing circuitry 400 is able to estimate the total latency associated with storing the current amount of state information and, through comparison to the total latency associated with waiting till a predicted minimum in which a total amount of state is less, the extension state processing circuitry is able to determine whether or not to defer the interrupt.

FIG. 11 schematically illustrates a sequence of steps carried out by the extension processing circuitry 400 in response to receiving an interrupt. Flow begins at step S450 where it is determined if an interrupt is received. If, at step S450, it is determined that no interrupt has been received, then flow remains at step S450. If, at step S450, it is determined that an interrupt has been received, then flow proceeds to step S452 where it is determined if the interrupt was generated by the extension processing circuitry 400. If, at step S452, it is determined the interrupt was generated by the extension processing circuitry 400, then flow proceeds to step S464 where the interrupt is forwarded to the data processing pipeline without deferring. If, at step S452, it is determined that the interrupt was not generated by the extension processing circuitry 400, then flow proceeds to step S454, where the extension processing circuitry 400 estimates the number of cycles required to save the current extension state information (X_{C}), for example, using an average extension state information saving rate. Flow then proceeds to step S456 where the extension processing circuitry 400 estimates a number of cycles required to save a predicted minimum state information (X_{P}), for example, using the average extension state information saving rate in combination with a predicted minimum extension state information size. Flow then proceeds to step S458, where the extension processing circuitry 400 determines a predicted number of cycles (N_{P}) till the amount of extension state information reaches the predicted minimum extension state information size. Flow then proceeds to step S460 where it is determined if the condition X_{C}> (X_{P}+N_{P}) is true or false. If the condition X_{C}> (X_{P}+N_{P}) is true, then flow proceeds to step S462 where the extension processing circuitry defers forwarding the interrupt until N_{P} cycles have passed. If, at step S460, it was determined that the condition X_{C}> (X_{P}+N_{P}) was not true (false), then flow proceeds to step S464, where the interrupt is forwarded to the data processing pipeline without deferring.

FIG. 12 schematically illustrates a configuration of the extension processing circuitry 480 in accordance with some configurations of the present techniques. The extension processing circuitry 480 is arranged as a spatial architecture. Such spatial architectures can accelerate some applications by unrolling or unfolding the computations, which form the most time-consuming portion of program execution, in space rather than in time. Computations are unrolled in space by using a plurality of hardware units (processing elements) capable of concurrent operation. In addition to taking advantage of the concurrency opportunities offered by disaggregated applications which have been spread out on a chip, spatial architectures can also take advantage of distributed on-chip memories. In this way, each processing element is associated with one or more memory blocks in close proximity to it. As a result, spatial architectures can circumvent the von-Neumann bottleneck which hinders performance of many traditional architectures.

In the illustrated configuration, the extension processing circuitry 480 comprises an array of processing elements which is connected to a cache hierarchy or main memory via interface nodes, which are otherwise referred to as interface tiles (ITs) and are connected to the network via multiplexers (X). Processing elements in the extension processing circuitry 480 in the illustrated configuration comprise two different types of circuitry. Each processing element comprises processing circuitry, otherwise referred to as compute tiles (CTs), and memory control circuitry, otherwise referred to as memory tiles (MTs). The role of the CTs is to perform the bulk of the data processing operations and arithmetic computations. The role of the MTs is to perform data accesses to locally connected memory (local storage circuitry) and data transfers to/from the more remote regions of memory and inter-processing element memory transfers between the processing element and other processing elements.

In some example configurations each of the processing elements of the extension processing circuitry 480 comprises local storage circuitry connected to each memory control circuit (MT) and each memory control circuitry (MT) has direct connections to one processing circuit (CT). Each MT-CT cluster is connected to a network-on-chip which is used to transfer data between memory control circuits (MTs) and between each memory control circuit (MT) and the interface node (IT). In alternative configurations local storage circuitry may be provided between plural processing elements and may be accessible by multiple memory control circuits (MTs). The processing elements may be also be conventional processing elements. Alternatively, the processing elements may be triggered processing elements in which an instruction is executed when a respective trigger condition or trigger conditions is/are met.

The processing elements of the extension processing circuitry 480 illustrated in FIG. 12 are each connected via a set of input and output channels to the network-on-chip which comprises switches, and data links between those switches forming a two-dimensional torus topological layout. Data can be routed around the network-on-chip using any algorithm. However, a particularly efficient routing algorithm is the xy routing algorithm modified to take the torus layout into account. The xy algorithm prevents routing deadlocks (cyclic dependence between processing elements and/or network resources which makes forward progress impossible) within the network by prohibiting data routed along the y direction from being subsequently routed along the x direction.

For configurations in which the extension processing circuitry is arranged in a distributed architecture, the extension processing circuitry is configured to perform processing using one of a first group of processing elements 482 and a second group of processing elements 484 whilst the other of the first group of processing elements 482 and the second group of processing elements 484 undergoes the process of having extension state information stored. For example, at a point of saving the extension state information, the extension processing circuitry may perform processing using the first group of processing elements 482 whilst state associated with the second group of processing elements 484 is saved. Then, subsequent to the saving of the extension state information associated with the second group, the second group of processing elements 484 may be used for processing whilst the extension state information associated with the first group of processing elements is saved. It would be readily apparent to the skilled person that the size and arrangement of groups is for illustrative purpose only and the size and number of groups can be arranged according to the requirements of the particular implementation of the extension processing circuitry 480.

FIG. 13 schematically illustrates further details of extension processing circuitry 470 according to some configurations of the present techniques. The extension processing circuitry 470 stores extension state information 472 and is provided with context switch prediction circuitry 478 and speculative context saving circuitry 476. The context switch prediction circuitry 478 is configured to predict a likelihood of an occurrence of a context switch. The context switch prediction circuitry 478 maintains one or more counters indicative of a number of cycles that have occurred between one or more recent pairs of context switches. By maintaining a count of a number of cycles that have occurred since a most recent context switch, the context switch prediction circuitry generates a prediction of a number of instruction cycles until the next context switch. The speculative context saving circuitry is responsive to the predicted number of instruction cycles of a context switch being below a predefined threshold (corresponding to a likelihood of a context switch occurring being above a further predefined threshold) to store at least a portion of the extension state information 472 speculatively (i.e., in advance of the context switch) as speculatively stored extension state information 474. The speculative context saving circuitry is further configured to maintain an indication of changes to the extension state information 472. Hence, at a point of a context switch, the extension processing circuitry 470 is able to save the indication of changes to the extension state information 472 (Δ state information) rather than saving the entire extension state information 472. As a result, the amount of extension state information 472 that is required to be saved at a point of the context switch can be reduced.

FIG. 14 schematically illustrates an apparatus 1200 according to some configurations of the present technique. The apparatus 1200 is provided with a data processing pipeline 1202 for processing a sequence of instructions and extension processing circuitry 1204. Both the data processing pipeline 1202 and the extension processing circuitry 1204 store state information. In particular, the data processing pipeline 1202 stores processing state information 1206 that is indicative of a processing context of the data processing pipeline 1202. The extension processing circuitry 1204 stores extension state information 1212 indicative of an extension processing context of the extension processing circuitry 1204. The data processing pipeline 1202 comprises decoder circuitry 1210 configured to receive a sequence of instructions and, in response to receiving the sequence of instructions, to control the data processing pipeline 1202 to perform the sequence of processing operations. The decoder circuitry 1210 is responsive to an extension context restore instruction comprising a location identifier to trigger the extension processing circuitry 1204 to restore previous extension state information 1214 from the location.

The operating system is able to use the extension context restore instruction, for example, during a context switch and subsequent to issuing an extension context save instruction to trigger the extension processing circuitry 1204 to perform a lazy restore of previous extension state information 1214 (i.e., only perform the restore if it is determined that the previous extension state information 1214 is different to the extension state information 1212) or an eager restore of the previous extension state information 1214 (i.e., perform the restore whenever a context switch occurs).

FIG. 15 schematically illustrates a sequence of steps carried out by the apparatus 1200 in accordance with various configurations of the present techniques. Flow begins at step S1250 where it is determined if the extension processing circuitry 1204 has been instructed to perform a delegated task. If no, then flow remains at step S1250. If, at step S1250, it was determined that the extension processing circuitry 1204 has been instructed to perform a delegated task then flow proceeds to step S1252. At step S1252 the extension processing circuitry 1204 performs the delegated task asynchronously to the data processing pipeline 1202 and maintains extension state information 1212 indicative of an execution context of the extension processing circuitry 1204. The extension state information 1212 is generated and maintained by the extension processing circuitry 1204 independent of the processing state information 1206 that is maintained by the data processing pipeline 1202. Flow then proceeds to step S1254 where it is determined, by the extension processing circuitry 1204, whether a context restore has been triggered, for example, due to an extension context restore instruction received by decoder circuitry 1210 of the data processing pipeline 1202 and the decoder circuitry 1210 issuing a trigger for the extension processing circuitry 1204 to restore previous extension state information 1214. The trigger is associated with a location identifier indicating a location from which the previous extension state information 1214 is to be restored. If, at step S1254, a trigger has not been received, then flow returns to step S1252. If, at step S1254, a trigger has been received then flow proceeds to step S1256 where the extension processing circuitry 1204 loads the previous extension state information 1214 from the location identified by the storage location identifier when restoration of previous extension state information associated with the previous execution context is required. In other words, the extension processing circuitry 1204 determines whether the trigger is a trigger indicating an extension context eager restore or an extension context lazy restore. In the case that an extension context eager restore is indicated the extension processing circuitry 1204 proceeds to restore the previous extension state information 1214 independent as to whether the previous extension state information 1214 is the same as or different from the extension state information 1212 (i.e., the extension state information that is already present in the extension processing circuitry). In the case that an extension context lazy restore instruction is indicated, the extension processing circuitry determines whether the previous extension state information 1214 is the same as or different from the extension state information 1212 (i.e., the extension state information that is already present in the extension processing circuitry) and, in the event that the extension state information 1212 is different to the previous extension state information 1214, the extension processing circuitry 1204 restores the previous extension state information 1214. Such a determination may be dependent on an identifier identifying the execution context with which the extension state information 1212 that is stored in the extension processing circuitry 1204 is associated. For example, the identifier may be compared to an identifier indicating the execution context which is to be loaded.

FIG. 16 illustrates a simulator implementation that may be used. Whilst the earlier described examples implement the present invention in terms of apparatus and methods for operating specific processing hardware supporting the techniques concerned, it is also possible to provide an instruction execution environment in accordance with the examples described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically a simulator implementation may run on a host processor 515, optionally running a host operating system 510, supporting the simulator program 505. In some arrangements there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990, USENIX Conference, Pages 53 to 63.

To the extent that examples have previously been described with reference to particular hardware constructs or features, in a simulated implementation equivalent functionality may be provided by suitable software constructs or features. For example, particular circuitry may be provided in a simulated implementation as computer program logic. Similarly, memory hardware, such as register or cache, may be provided in a simulated implementation as a software data structure. In arrangements where one or more of the hardware elements referenced in the previously described examples are present on the host hardware (for example host processor 515), some simulated implementations may make use of the host hardware, where suitable.

The simulator program 505 may be stored on a computer readable storage medium (which may be a non-transitory medium), and provides a virtual hardware interface (instruction execution environment) to the target code 500 (which may include applications, operating systems and a hypervisor) which is the same as the hardware interface of the hardware architecture being modelled by the simulator program 505. Thus, the program instructions of the target code 500 may be executed from within the instruction execution environment using the simulator program 505, so that a host computer 515 which does not actually have the hardware features of the apparatus described in relation to FIGS. 1 to 15 can emulate those features. The simulator program may include data processing pipeline logic 520 to emulate the behaviour of the data processing pipeline and extension processing logic 525 to emulate the behaviour of the extension processing circuitry. Hence, the techniques described herein for storing extension state information can in the example of FIG. 16 be performed in software by the simulator program 505.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus, a method of operating an apparatus, a computer program, and a computer-readable medium. The apparatus comprises a pipeline for processing instructions. The pipeline comprises decoder circuitry responsive to receipt of the instructions to control the pipeline to perform processing operations. The apparatus further comprises extension processing circuitry responsive to identification, by the pipeline, of a delegated task to perform the delegated task asynchronously to the pipeline and configured to maintain extension state information indicative of an execution context of the extension processing circuitry independent of processing state information associated with the pipeline. The decoder circuitry is responsive an extension context save instruction comprising a storage location identifier, at a point of storing the extension state information, to store the extension state information to a location identified by the storage location identifier.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations have been described in detail herein with reference to the accompanying drawings, it is to be understood that the invention is not limited to those precise configurations, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

The invention may also be described by the following numbered clauses:

Clause 1. An apparatus comprising:
a data processing pipeline for processing a sequence of instructions, wherein the data processing pipeline comprises decoder circuitry responsive to receipt of instructions of the sequence of instructions to generate control signals to control the data processing pipeline to perform processing operations; and
extension processing circuitry responsive to identification, by the data processing pipeline, of a delegated task to perform the delegated task asynchronously to the data processing pipeline,
wherein:
the extension processing circuitry is configured to maintain extension state information indicative of an execution context of the extension processing circuitry independent of processing state information associated with the data processing pipeline; and
the decoder circuitry is responsive to an extension context save instruction comprising a storage location identifier, at a point of storing the extension state information, to store the extension state information to a location identified by the storage location identifier.

Clause 2. The apparatus of clause 1, wherein the decoder circuitry is further responsive to the extension context save instruction comprising the storage location identifier to trigger the extension processing circuitry to perform a context switch from the execution context to a further execution context

Clause 3. The apparatus of clause 2, wherein:
the decoder circuitry is responsive to the extension context save instruction specifying an extension context eager save, to generate extension context eager save control signals; and
the extension processing circuitry is responsive to the extension context eager save control signals to store the extension state information to the location independent of whether the extension state information is predicted to be modified by the extension processing circuitry whilst operating in the further execution context.

Clause 4. The apparatus of clause 3, wherein:
the extension processing circuitry is responsive to the eager context save control signals, to retain the extension state information and to maintain modification information indicative of whether the extension state information is modified prior to a further context switch from the further execution context back to the execution context.

Clause 5. The apparatus of any preceding clause, wherein the decoder circuitry is responsive to the extension context save instruction specifying an extension context lazy save, to generate extension context lazy save control signals; and
the extension processing circuitry is responsive to the extension context lazy save control signals to defer storing the extension state information until a point at which it is determined that a further delegated task belonging to the further execution context requires the extension processing circuitry to access the extension state information.

Clause 6. The apparatus of clause 5, wherein the extension processing circuitry is configured to:
store the storage location identifier to a secure region of storage; and
at the point at which it is determined that the further delegated task requires the extension processing circuitry to modify the extension state information, to retrieve the storage location identifier from the secure region of storage and store the extension state information to the location identified by the storage location identifier.

Clause 7. The apparatus of clause 2, wherein the extension processing circuitry is configured to maintain a indication of a likelihood that the extension state information will be modified by the further execution context, and to determine whether to perform an extension context lazy save or an extension context eager save dependent on the indication.

Clause 8. The apparatus of any preceding clause, wherein the extension processing circuitry is configured to receive an indication of an interrupt intended for the data processing pipeline, and to perform a determination of whether to defer the interrupt based on current state size information indicative of a size of the extension state information.

Clause 9. The apparatus of clause 8, wherein:
the extension processing circuitry comprises extension state size prediction circuitry configured to determine predicted future state size information indicative of a predicted future size of the extension state information; and
the extension processing circuitry is configured to perform the determination of whether to defer based on a comparison between the current state size information and the predicted future state size information.

Clause 10. The apparatus of clause 9, wherein the predicted future state size information comprises an indication of a predicted minimum extension state size and a predicted number of cycles until the extension state information reaches the predicted minimum extension state size.

Clause 11. The apparatus of clause 10, wherein the extension processing circuitry is configured to:
calculate a current save cost estimating a number of cycles required to save the state information based on the current state size information;
calculate a deferred save cost estimating a number of cycles required to save the state information based on the predicted minimum extension state size and the predicted number of cycles; and
determine to defer the interrupt based on a comparison of the deferred save cost and the current save cost.

Clause 12. The apparatus of any of clauses 8 to 11, wherein the extension state size prediction circuitry comprises a plurality of prediction tables, each of the one or more prediction tables comprising entries indexed based on an extension progress indicator, and each of the entries identifying corresponding state size information for a corresponding extension progress indicator value.

Clause 13. The apparatus of any preceding clause, wherein:
the extension processing circuitry is arranged in a distributed architecture comprising a plurality of processing elements; and
the extension state information comprises processing element state information indicative of a state of each of the plurality of processing elements.

Clause 14. The apparatus of clause 13, when dependent on any of clauses 8 to 12, wherein:
each processing element of the processing elements is configured to store an active state indication identifying whether the processing element state information associated with that processing element is modified processing element state information or non-modified processing element state information; and
the extension processing circuitry is configured to calculate the size of the extension state information based on a number of processing elements for which the active state information indicates that the state of that processing element is modified processing element state information.

Clause 15. The apparatus of clause 13 or clause 14, wherein:
the plurality of processing elements are grouped into a plurality of processing element groups; and
the extension processing circuitry is configured to trigger timing of the storage of the processing element state information independently for each of the plurality of processing element groups.

Clause 16. The apparatus of clause 15, wherein the extension processing circuitry is configured to trigger the storage of the processing element state information associated with each of the plurality of processing elements belonging to a first group of the plurality of processing element groups, and to cause each of the plurality of processing elements belonging to a second group to perform processing in one of the processing context and the further processing context.

Clause 17. The apparatus of clause 16, wherein the extension processing circuitry is configured to cause each of the plurality of processing elements belonging to the second group to perform processing in the processing context, and the extension processing circuitry is configured to cause each of the plurality of processing elements belonging to a third group to perform processing in the further processing context.

Clause 18. The apparatus of any of clauses 15 to 17, wherein the extension processing circuitry is configured to trigger the timing for each of the plurality of processing element groups sequentially.

Clause 19. The apparatus of any preceding clause, wherein the extension processing circuitry comprises:
speculative context saving circuitry configured to perform a speculative context store of at least a portion of the extension state information in response to a prediction that the probability of occurrence of the context switch is above a predetermined threshold.

Clause 20. The apparatus of clause 19, wherein the extension processing circuitry comprises context switch prediction circuitry configured to generate the prediction of the probability of occurrence of the context switch.

Clause 21. The apparatus of clause 19 or clause 20, wherein the prediction is based on periodic elapse of a predefined period.

Clause 22. The apparatus of any of clauses 19-21, wherein the prediction is based on occurrence of a local minimum extension state size.

Clause 23. The apparatus of any of clauses 19-22, wherein the context switch prediction circuitry is configured to calculate the probability of occurrence of the context switch periodically.

Clause 24. The apparatus of any of clauses 19 to 23 wherein the speculative context saving circuitry is configured to maintain information indicative of the speculatively stored extension state information; and
the extension processing circuitry is responsive, at a point of resolution of the speculative context store, to a determination that the speculatively stored extension state information is different from the extension state information, to update the speculatively stored extension state information based on a difference between the speculatively stored extension state information and the extension state information.

Clause 25. The apparatus of any preceding clause, wherein the extension processing circuitry is configured to store at least some of the extension state information at a same time as the data processing pipeline stores at least some of the processing state information.

Clause 26. The apparatus of any preceding clause, wherein the extension processing circuitry is configured to compress the extension state information prior to storing.

Clause 27. An apparatus comprising:
a data processing pipeline for processing a sequence of instructions, wherein the data processing pipeline comprises decoder circuitry responsive to receipt of instructions of the sequence of instructions to generate control signals to control the data processing pipeline to perform processing operations; and
extension processing circuitry responsive to identification, by the data processing pipeline, of a delegated task to perform the delegated task asynchronously to the data processing pipeline,
wherein:
the extension processing circuitry is configured to maintain extension state information indicative of an execution context of the extension processing circuitry independent of processing state information associated with the data processing pipeline; and
the decoder circuitry is responsive an extension context restore instruction comprising a storage location identifier, to trigger the extension processing circuitry to perform a context switch from the execution context to a previous execution context and, in response to an indication that previous extension state information associated with the previous execution context is required to be restored, to load the previous extension state information from a location identified by the storage location identifier.

Clause 28. The apparatus of clause 27, wherein the extension processing circuitry comprises:
context switch prediction circuitry configured to predict a probability of utilization of the extension processing circuitry prior to a next context switch; and
speculative context loading circuitry configured to perform a speculative context load of at least a portion of the previous extension state information in response to a prediction, by the context switch prediction circuitry, that the probability of utilization of the extension processing circuitry is above a predetermined threshold.

Clause 29. A non-transitory computer-readable medium to store computer-readable code for fabrication of the apparatus of any of clauses 1 to 28.

1. An apparatus comprising:
a data processing pipeline for processing a sequence of instructions, wherein the data processing pipeline comprises decoder circuitry responsive to receipt of instructions of the sequence of instructions to generate control signals to control the data processing pipeline to perform processing operations; and
extension processing circuitry responsive to identification, by the data processing pipeline, of a delegated task to perform the delegated task asynchronously to the data processing pipeline,
wherein:
the extension processing circuitry is configured to maintain extension state information indicative of an execution context of the extension processing circuitry independent of processing state information associated with the data processing pipeline; and
the decoder circuitry is responsive to an extension context save instruction comprising a storage location identifier, at a point of storing the extension state information, to store the extension state information to a location identified by the storage location identifier.

2. The apparatus of claim 1, wherein the decoder circuitry is further responsive to the extension context save instruction comprising the storage location identifier to trigger the extension processing circuitry to perform a context switch from the execution context to a further execution context.

3. The apparatus of claim 2, wherein:
the decoder circuitry is responsive to the extension context save instruction specifying an extension context eager save, to generate extension context eager save control signals; and
the extension processing circuitry is responsive to the extension context eager save control signals to store the extension state information to the location independent of whether the extension state information is predicted to be modified by the extension processing circuitry whilst operating in the further execution context.

4. The apparatus of claim 3, wherein:
the extension processing circuitry is responsive to the extension context eager save control signals, to retain the extension state information and to maintain modification information indicative of whether the extension state information is modified prior to a further context switch from the further execution context back to the execution context.

5. The apparatus claim 1, wherein the decoder circuitry is responsive to the extension context save instruction specifying an extension context lazy save, to generate extension context lazy save control signals; and
the extension processing circuitry is responsive to the extension context lazy save control signals to defer storing the extension state information until a point at which it is determined that a further delegated task associated with the further execution context requires the extension processing circuitry to access the extension state information.

6. The apparatus of claim 5, wherein the extension processing circuitry is configured to:
store the storage location identifier to a secure region of storage; and
at the point at which it is determined that the further delegated task requires the extension processing circuitry to modify the extension state information, to retrieve the storage location identifier from the secure region of storage and store the extension state information to the location identified by the storage location identifier.

7. The apparatus of claim 2, wherein the extension processing circuitry is configured to maintain an indication of a likelihood that the extension state information will be modified by the further execution context, and to determine whether to perform an extension context lazy save or an extension context eager save dependent on the indication.

8. The apparatus of claim 1, wherein the extension processing circuitry is configured to receive an indication of an interrupt intended for the data processing pipeline, and to perform a determination of whether to defer the interrupt based on current state size information indicative of a size of the extension state information.

9. The apparatus of claim 8, wherein:
the extension processing circuitry comprises extension state size prediction circuitry configured to determine predicted future state size information indicative of a predicted future size of the extension state information; and
the extension processing circuitry is configured to perform the determination of whether to defer based on a comparison between the current state size information and the predicted future state size information.

10. The apparatus of claim 9, wherein the predicted future state size information comprises an indication of a predicted minimum extension state size and a predicted number of cycles until the extension state information reaches the predicted minimum extension state size.

11. The apparatus of claim 10, wherein the extension processing circuitry is configured to:
calculate a current save cost estimating a number of cycles required to save the state information based on the current state size information;
calculate a deferred save cost estimating a number of cycles required to save the state information based on the predicted minimum extension state size and the predicted number of cycles; and
determine to defer the interrupt based on a comparison of the deferred save cost and the current save cost.

12. The apparatus of claim 8, wherein the extension state size prediction circuitry comprises a plurality of prediction tables, each of the one or more prediction tables comprising entries indexed based on an extension progress indicator, and each of the entries identifying corresponding state size information for a corresponding extension progress indicator value.

13. The apparatus of claim 8, wherein:
the extension processing circuitry is arranged in a distributed architecture comprising a plurality of processing elements; and
the extension state information comprises processing element state information indicative of a state of each of the plurality of processing elements.

14. The apparatus of claim 13, wherein:
each processing element of the processing elements is configured to store an active state indication identifying whether the processing element state information associated with that processing element is modified processing element state information or non-modified processing element state information; and
the extension processing circuitry is configured to calculate the size of the extension state information based on a number of processing elements for which the active state information indicates that the state of that processing element is modified processing element state information.

15. The apparatus of claim 13, wherein:
the plurality of processing elements are grouped into a plurality of processing element groups; and
the extension processing circuitry is configured to trigger timing of the storage of the processing element state information independently for each of the plurality of processing element groups.

16. (canceled)

17. The apparatus of claim 1, wherein the extension processing circuitry comprises:
speculative context saving circuitry configured to perform a speculative context store of at least a portion of the extension state information in response to a prediction that the probability of occurrence of the context switch is above a predetermined threshold.

18. (canceled)

19. (canceled)

20. (canceled)

21. (canceled)

22. (canceled)

23. An apparatus comprising:
a data processing pipeline for processing a sequence of instructions, wherein the data processing pipeline comprises decoder circuitry responsive to receipt of instructions of the sequence of instructions to generate control signals to control the data processing pipeline to perform processing operations; and
extension processing circuitry responsive to identification, by the data processing pipeline, of a delegated task to perform the delegated task asynchronously to the data processing pipeline,
wherein:
the extension processing circuitry is configured to maintain extension state information indicative of an execution context of the extension processing circuitry independent of processing state information associated with the data processing pipeline; and
the decoder circuitry is responsive to an extension context restore instruction comprising a storage location identifier, to trigger the extension processing circuitry, in response to an indication that restoration of previous extension state information associated with the previous execution context is required, to load the previous extension state information from a location identified by the storage location identifier.

24. The apparatus of claim 23, wherein the extension processing circuitry comprises:
context switch prediction circuitry configured to predict a probability of utilization of the extension processing circuitry prior to a next context switch; and
speculative context loading circuitry configured to perform a speculative context load of at least a portion of the previous extension state information in response to a prediction, by the context switch prediction circuitry, that the probability of utilization of the extension processing circuitry meets a predetermined condition.

25. A non-transitory computer-readable medium to store computer-readable code for fabrication of the apparatus of claim 1.

26. A method of operating an apparatus comprising a data processing pipeline for processing a sequence of instructions, wherein the data processing pipeline comprises decoder circuitry responsive to receipt of instructions of the sequence of instructions, to generate control signals to control the data processing pipeline to perform processing operations, the method comprising:
with extension processing circuitry and in response to identification, by the data processing pipeline, of a delegated task, performing the delegated task asynchronously to the data processing pipeline;
maintaining, using the extension processing circuitry, extension state information indicative of an execution context of the extension processing circuitry independent of processing state information associated with the data processing pipeline; and
with the decoder circuitry, in response to an extension context save instruction comprising a storage location identifier, triggering the extension processing circuitry to perform a context switch from the execution context to a further execution context and, at a point of storing the extension state information, storing the extension state information to a location identified by the storage location identifier.

27. (canceled)

28. (canceled)

29. (canceled)
